(19) United States
(12) Patent Application Publication
(10) Pub. No.: US 2025/0178939 A1
(43) Pub. Date: Jun. 5, 2025

(54) INTENSIFIED FERMENTATION FOR DECARBONIZATION

(71) Applicant: Black & Veatch Holding Company, Overland Park, KS (US)

(72) Inventors: Leon Scott Downing, Overland Park, KS (US); Sudhir Murthy, Overland Park, KS (US); Bernhard Wett, Overland Park, KS (US); Eugenio Giraldo, Overland Park, KS (US); Nerea Uri Carreno, Overland Park, KS (US); Haydee De Clippeleir, Overland Park, KS (US)

(21) Appl. No.: 18/965,692

(22) Filed: Dec. 2, 2024

Related U.S. Application Data
(60) Provisional application No. 63/569,538, filed on Mar. 25, 2024.
(60) Provisional application No. 63/605,169, filed on Dec. 1, 2023.

(51) Int. Cl. C02F 3/12; C02F 3/00; C02F 11/02

(52) U.S. Cl. CPC C02F 3/1236; C02F 3/006; C02F 3/1278; C02F 11/02; C02F 2209/003; C02F 2209/08

(57) ABSTRACT

A system and method for improved fermentation and elutriation of wastewater solids by controlling the concentration of inhibitory products in the fermenter using enhanced elutriation, micro-aeration or fractional aeration, and pH control, and improved characteristics of the elutriated product by controlling the leakage of phosphorus and reducing the formation of odorous sulfur compounds.

### RELATED APPLICATIONS

This regular utility non-provisional patent application claims priority benefit with regard to all common subject matter of U.S. Provisional Patent Application Ser. No. 63/605,169, filed Dec. 1, 2023, entitled “SYSTEM AND METHOD OF IMPROVED FERMENTATION AND ELUTRIATION OF WASTEWATER SOLIDS” and U.S. Provisional Patent Application Ser. No. 63/569,538, filed Mar. 25, 2024, entitled “INTENSIFIED FERMENTATION FOR DECARBONIZATION”. The above-identified patent applications are hereby incorporated by reference in their entireties into the present patent application.

### BACKGROUND

Decarbonization of wastewater treatment plants is the process of reducing or eliminating carbon emissions associated with the treatment of wastewater. This can be achieved by implementing various strategies and technologies that minimize energy consumption, utilize renewable energy sources, and reduce greenhouse gas emissions.

Particulate COD refers to chemical oxygen demand (COD) associated with particulate matter in wastewater and is a commonly used parameter in wastewater treatment to assess the organic pollution level in the water. In fact, COD is the most valuable keystone component for any wastewater or wet waste source when evaluating decarbonization. Not only does particulate COD provide the potential for energy production, but it is also the limiting constituent to enable sustainable nutrient removal. Removing nitrogen and phosphorus from wastewater is the core principle of wastewater management, and COD cannot be diverted to energy at the expense of sustainable nutrient removal. The production of biogas or carbon-based products, the ability to remove nutrients in a sustainable manner, and the net solids production rate are all driven by the management of particulate COD. Particulate COD is often harvested from a waste stream through a physical separation step, such as primary clarifiers, dissolved air flotation (DAF), or filtration. This concentrated stream of particulate COD is then available for fermentation, digestion, biological nutrient removal, and ultimately beneficial reuse via land application of biosolids. Recent trends towards adoption of Advanced Primary Treatment (APT) are increasing removal rates of particulate COD upstream of nutrient removal. This carbon redirection strategy improves biogas production and reduces plant aeration, but uptake of APT is hampered by concerns over availability of specific soluble carbon products which act as critical inputs for phosphorus accumulating and denitrifying organisms.

The current state of the art in the industry is to incorporate a fermentation reaction step to manage this particulate COD in an attempt to balance the benefits of biogas production and nutrient removal. While fermentation is key to balancing decarbonization efforts associated with energy production, energy consumption, the carbon footprint of nutrient removal, and net biosolids production, it is an underdeveloped market for technologies because of conflicting motives for management of such carbon. Fermentation reactors are often little more than oversized gravity thickeners, and the important step of fermentation is not optimized, regulated, or intensified. This results in inconsistent results, lack of control, and an inability to balance operational setpoints to optimize biogas production and biosolids production This is true across all of the different wastewater sectors.

Furthermore, wastewater treatment plants employ fermenters as part of an advanced treatment process to produce valuable volatile fatty acids (VFAs) from primary and excess sludge produced in biological processes for wastewater treatment, referred in independent or combined forms herein as wastewater solids. Primary sludge is the solid material that settles out during the initial stages of wastewater treatment. Excess biological sludge, such as but not limited to waste activated sludge, is the result of excess growth of microorganisms responsible for treatment in the biological treatment process. The use of fermenters in this context is a sustainable and resource-recovery approach that aims to convert organic matter in the wastewater solids into VFAs, which are valuable for improving the removal of nutrients within the plant, as well as precursors for bioenergy production, bioplastics, and other bioproducts. In the fermenter, the primary or raw (as sourced from the raw wastewater) wastewater solids undergoes anaerobic fermentation, a biological process facilitated by a diverse consortium of microorganisms.

### SUMMARY

Embodiments of the present invention provide an intensified fermentation reactor and process (inFERMx) that can be deployed at various points within a plant's liquid or sludge processing flow to replace or augment existing process equipment such as primary settlers, anaerobic zones of secondary treatment, gravity thickeners, sludge equalization (EQ) tanks, acid digester tanks, or primary filter backwash settling tanks. The intensified fermentation reactor may improve the state of the art in several key manners by incorporating several stages into a single, unified system for operation and control. In particular, the intensified fermentation reactor broadly comprises a microscreen stage, a pre-conditioning stage, a micro-aeration/fractional aeration stage, and an elutriation stage. The intensified fermentation reactor also includes instrumentation and control. The microscreen stage provides sludge strain press for biosolids improvements. To that end, the microscreen stage filters rags, screening material, and inert matter, which produces better fermentation/digestion efficiency, lower solids production rates, and improved biosolids quality. The pre-conditioning stage physically, chemically or biologically conditions particulate streams for fermentation. This increases fermentation rates or yields by 25% to 75%. The fractional aeration or simultaneous micro-aeration stage activates the fermentation process. Micro-aeration/fractional aeration in alternating activated adsorption (AAA) primary treatment processes may increase the net yield of fermentation. The elutriation stage enables enhanced elutriation of soluble COD rich streams to redirect to biological nutrient removal processes. In thickening fermentation processes, the concentration of soluble COD can build in the settled sludge blanket. This can begin to limit additional soluble COD production, which is the needed ingredient for nutrient removal. Effecting feedback control approaches to ensure that the biological processes are not inhibited kinetically and stochiometrically is critical and novel. The instrumentation and control applies to fermentation reactor components. The inFERMx process may incorporate SENTRY or microbial/respirometric sensors, UV/Vis COD sensors or COD soft sensors, which enables control of pre-treatment, micro-aeration/fractional aeration, and elutriation. This may provide the ability to balance the soluble COD production to meet the exact nutrient removal needs, ensuring that the maximum amount of COD is diverted to biogas production while still maintaining effluent limits.

The linking of labile COD or VFA (or readily biodegradable COD, rbCOD or floc filtered COD, ff COD, or soluble COD, sCOD) production in a fermenter with BNR and/or granule formation within a BNR system is another key part of our inventive disclosure. To that end, the present invention also describes a system, apparatus, and method for controlling the conditions of the fermentation reaction using elutriation and/or micro-aeration/fractional aeration, and/or pH control using chemicals in novel ways, controlling the ORP of the reaction to enhance hydrolysis (increase rate, more complete reactions and increasing extent), reduce the formation of odorous compounds, and enabling the use of chemicals during fermentation to control pH and manage the leakage of phosphorus in the elutriated product. The elutriant is used to directly transport out of the system the VFA formed during fermentation (and a key inventive step) and not after fermentation as is the current practice. Addition of chemicals for pH control or P sequestering along with the elutriant reduces the inhibitory impact of VFA enhancing reaction rates and yields. Optional micro-aeration/fractional aeration and mixing with ORP control using coarse or fine bubble mixing (using any approach including diffusers, duckbills or jet aeration) depending on application also further enhances the overall process. The present invention dovetails the micro-aeration/fractional aeration and/or elutriant enhanced fermentation with biological nutrient removal as thereby producing the appropriate quantity and quality of carbon mix for biological nutrient removal. The concept of micro-aeration is herein defined as the use of air to activate the hydrolytic process or to produce VFAs (especially excess VFAs). This concept can be measured using ORP (values between +20 and −400 mV in at least part of the retention/reaction time), pH, as excess labile COD, excess VFA, or excess rbCOD production. The concept of fractional aeration is the use of higher dissolved oxygen concentrations or ORP compared to micro-aeration but for short time intervals compared to a cycle time or process HRT/SRT. The measurements of VFA or rbCOD production can be made using any type of sensor including a physical (such as but not limited to UV absorbance), chemical, or biosensor (including and not limited to respirometry or as provided by a SENTRY analyzer) approach. Excess VFA is the amount of extra VFA produced for a hydraulic retention time compared to the absence of such micro-aeration or fractional aeration. Micro-aeration or fractional aeration can be supplied using air or pure oxygen, especially if pure oxygen is available from electrolysis as an inventive approach. The delivery of micro-aeration or fractional aeration can be using jet mix, coarse bubbles, or any method typically used to aerate mixed liquor or sludges (such as fine bubble or nano bubble equipment).

There are six locations where this “micro-aeration/fractional aeration plus elutriation” enhanced fermentation can take place: 1) primary tanks or as part of a primary process (to produce VFA enriched effluent), 2) bioreactor (in the anaerobic or anoxic zone), 3) in a gravity thickener or dedicated fermenter, 4) in a return activated sludge fermentation zone, or 5) a separate vessel location upstream of any of the previous four locations that receives various treatment streams or 6) a multi-stage or sequenced acid digester. Micro-aeration or fractional aeration by itself or coupled with air-lift can also be used to provide the required hydraulic head to displace the fermenting liquor between two tanks in series to hydraulically meet the grade requirements for retrofits.

The primary process is broadly described as being located downstream of preliminary treatment (screens and/or grit removal) and upstream of the secondary process (for processes such as BNR and nitrification). The primary process in this case is subject to aeration and produces fermenting microorganisms in either suspended growth or biofilm processes. In primary tanks, this enhanced fermentation concept can take place as a) tanks in parallel or as a sequenced batch process (for suspended growth or mobile biofilms) or tanks in series or as a continuous flow process (for suspended growth or mobile biofilms) or b) using biofilm media (such as polymeric, and including polypropylene or polystyrene) for biofilms that need to be contained (fixed or mobile). A thickening approach can be included in this primary (such as in the Alternating Activated Adsorption settler to help further ferment the solids and a more concentrated VFA stream can be generated. Any VFA or rbCOD (readily biodegradable COD) rich effluent from this primary or thickener can (as an inventive step) be sent to BNR and used for internal or external carbon storage processes (glycogen, polyhydroxyalkanoate, etc.) or directly for use in denitrification, as in partial denitrification/anammox (PdNA). The use of such primary or raw wastewater solids fermentation approaches for storage based BNR or PdNA is herein disclosed. This approach can especially facilitate needed fermentation in winter in temperate regions or where sufficient hydrolysis does not take place in the sewers. The fermentation can be assisted with an alkali for pH control and management of inhibitory unionized volatile fatty acids. The added alkali simultaneously improves the use of inorganic carbon in the influent that is available for nitrifiers. In a special case and embodiment of this invention, the alkali mitigates the production of N2O (nitrous oxide). This dual benefit of providing COD based carbon for heterotrophs (including and not limited to denitrifiers and phosphorus removing organisms and inorganic carbon for nitrifiers, while addressing inhibition in the fermentation process itself is an inventive approach). This approach can be implemented in any location, including and not limited to primary, anaerobic/anoxic/aerobic selector stage/zone of secondary, gravity thickener, return activated sludge or acid digester. A fixed decanter (such as an air lock decanter) can be used for withdrawing the elutriate. Thus, the system consists of a fermentation with active mixing step (optionally including micro-aeration/fractional aeration for enzyme/extracellular polymeric substance production) and continued fermentation in a feeding-elutriation step for production and evacuation of the inhibitory products of fermentation to a BNR process downstream. The fractional aeration ‘activation’ step can range from 5% to 20% (as representative fractions) of the cycle time (example of 6 min in a cycle time of one hour) or 1% to 20% of the total system hydraulic retention time if applied to a continuous flow system, to minimize conversion of carbon to CO2 (preferably less than 5% to 15% conversion of influent COD) and yet provide activation for the hydrolysis and fermentation. Settling and removal of accumulated sludge are also incorporated within the cycles as needed. The VFA production can occur in all of the cycle steps depending on the process. The primary tanks can be tanks in series mode and as continuous flow tanks (for larger plants) or tanks in parallel mode or sequenced (within the same tank) for both small and large plants. An air lift pump could be used for transfer between two series primary tanks or in a parallel primary tank to an included gravity thickener (in the hopper region of the primary) for additional fermentation and VFA release. Again, micro-aeration or fractional aeration either continuously (low DO) or intermittently (on and off) is provided as an activation step to improve hydrolysis, provide buffering as needed, minimize carbonic acid (CO2) production, and improve its stripping to ameliorate the decrease in pH. One optional feature of the present invention is to bio-augment the primary process with sludge from downstream bioreactor (wasting waste activated sludge to primary) containing storage organisms to uptake the VFA produced (and as carbon storing biocarriers) with part of these organisms being sent back (in the primary effluent) to the BNR process (in a systemic bioaugmentation scheme between the primary and secondary process). Here, carbon storage is defined as the production of polymers that could include substances that are internal or external to the microorganism that are used for biological nutrient removal.

Features of the present invention could include: fermenting with active mixing which may be provided by micro-aeration or fractional aeration or a combination of mechanical, hydraulic, and aeration as needed to control ORP, a settling step to form a clarified liquid and a sludge blanket, a sludge removal step to waste some of the accumulated sludge, and a feeding elutriation step where feeding of wastewater is done at the bottom of the fermenter, thereby forcing contact with the sludge blanket for collection of dispersed particles within the sludge blanket and simultaneous elutriation of liquid within the blanket and displacement of clarified liquid on the surface of the vessel rich in VFA to be conveyed to a downstream BNR process. The process could be batch (sequencing) or continuous. The continuous approach preferably has a feed and aeration at the bottom of the fermenter elutriating the reacting mixture to the series tank. In the next series tank, the sludge is settled and elutriated through a settling blanket. A part of the settled sludge can be re-mixed with influent wastewater solids in the first tank as needed to improve the fermentation reaction or to manage the solids residence time of the overall process.

Active mixing, optionally including micro-aeration/fractional aeration plus elutriation based fermentation, could occur in an anaerobic/anoxic selector (either sequencing batch (tanks in parallel) or two selectors in series). In parallel mode, the feed is added preferably from the bottom of the fermenter either with a discharge pipe or a feed manifold, a blanket is allowed to form, and the feed elutriates and displaces the VFA rich effluent for further downstream reaction and use of stored material. In one important parallel mode, a contact stabilization approach is provided where the sludge or influent feed piping is placed in the downstream second step to elutriate the VFA rich effluent, and the sludge from the second step (using an internal or external clarifier) is sent to the stabilization step for air activation. Here again, the fractional aeration for activation represents approximately 5% to 20% (as a representative fraction) of the hydraulic retention time or solids residence time of the hydrolyzing and fermenting stage/zone/apparatus. A higher activation time than the range may be needed if the oxygen transfer efficiency is low in the apparatus (such as for thickened sludge or for sludges with low alpha factor or viscosity). This approach minimizes the formation of CO2 (preferably less than 5% to 15% of overall influent COD).

Air is optionally added in a sequenced, intermittent or continuous reaction cycle step to increase VFA production and to maintain sufficient redox conditions in the react step that can be distinct from the settle and elutriation step. The biological storage of carbon is encouraged in the selector. A decanter (including air-lock decanter) could be used to elutriate the effluent. Thus, as one option, two such optionally micro-aerated selectors could be operated in parallel (one in react mode and the other in settle/feed/decant mode). Optionally, big bubble mixers may be added to the sequenced operations. The parallel operation can be a fermentation-elutriation process in time sequenced step where the mixing and micro-aeration/fractional aeration is performed in the fermentation step such as for activation and hydrolysis and the feed displaces the effluent through a blanket containing fermented substrates in the feeding-elutriation step.

In another embodiment (especially in series mode), the feed from the bottom may dilute the fermenting and reacting sludge (micro-aeration/fractional aeration is performed as needed) to manage pH and ORP and elutriating the liquor to a downstream reactor where a blanket forms and allows for the displacement of a storage rich liquor to downstream processes. The opposite approach (in series mode) is envisioned where a downstream contact step is preceded by a stabilization step where either intermittent aeration or micro-aeration is performed. The series mode can be used in combination with all described reactors, with the addition of a reactor vessel upstream that enables intermittent aeration, micro-aeration, and/or mechanical mixing for pre-conditioning of the solids.

Thick sludge fermentation could occur in a gravity thickener or in a dedicated off-line fermenter. In this case, the micro-aeration is supplied using coarse bubble diffusers, jet mix/aeration, nozzle aeration, floating aerators, or other approaches in a tank upstream of the thick sludge fermentation reactor.

Certain embodiments of the present invention will now be briefly summarized. An embodiment is an intensified fermentation reactor system broadly comprising a micro-screening stage, a pre-conditioning stage, a micro-aeration/fractional aeration stage, an elutriation stage, and an instrumentation and control system. The micro-screening stage is configured to strain a concentrated particulate COD stream. The pre-conditioning stage is configured to physically condition the concentrated particulate COD stream. The micro-aeration/fractional aeration stage is configured to activate fermentation. The elutriation stage is configured to elutriate fermentation. The instrumentation and control system is configured to effect feedback control of elutriation thereby optimizing diversion of COD for energy production while maintaining an effluent limit.

Another embodiment is a method of fermentation broadly comprising steps of straining a concentrated particulate COD stream in a micro-screening stage, physically conditioning the concentrated particulate COD stream in a pre-conditioning stage, activating fermentation in a micro-aeration/fractional aeration stage, elutriating the fermentation in an elutriation stage, and effecting feedback control of elutriation via an instrumentation and control system thereby optimizing diversion of COD for energy production while maintaining an effluent limit.

Another embodiment is a fermenting system comprising a wastewater solids source, an elutriant source, and a fermenter vessel configured to receive wastewater solids from the wastewater solids source, receive elutriant from the elutriant source, ferment sludge, and remove an elutriated product from the fermenter vessel.

Another embodiment is a method of fermentation comprising steps of adding wastewater solids to a fermenter vessel, fermenting the wastewater solids in the fermenter vessel while missing the wastewater solids thereby forming a fermenting mixed liquor, clarifying the fermenting mixed liquor thereby forming a sludge blanket zone and a clarified liquid zone, collecting at least a portion of the clarified liquid to form an elutriated product, allowing the fermenting mixed liquor to settle thereby forming a thickened sludge, and collecting a portion of the thickened sludge.

### BRIEF DESCRIPTION OF THE DRAWING FIGURES

Embodiments of the present invention are described in detail below with reference to the attached drawing figures, wherein:

FIG. 1 is a schematic diagram of waste system constructed in accordance with an embodiment of the present invention

FIG. 2A is a side elevation view of a fermenting system constructed in accordance with an embodiment of the present invention;

FIG. 2B is a side elevation view of the fermenting system of FIG. 2A;

FIG. 2C is an addition of a pre-conditioning vessel to the fermentation systems of FIG. 2A and FIG. 2B;

FIG. 3A is a side elevation view of a fermenting system constructed in accordance with another embodiment of the invention;

FIG. 3B is a side elevation view of the fermenting system of FIG. 3A;

FIG. 3C is a side elevation view of the fermenting system of FIG. 3A;

FIG. 3D is a side elevation view of the fermenting system of FIG. 3A;

FIG. 3E is a side elevation view of the fermenting system of FIG. 3A;

FIG. 4A is a side elevation view of a fermenting system constructed in accordance with another embodiment of the invention;

FIG. 4B is a side elevation view of the fermenting system of FIG. 4A;

FIG. 4C is a side elevation view of the fermenting system of FIG. 4A;

FIG. 4D is a side elevation view of the fermenting system of FIG. 4A;

FIG. 4E is a side elevation view of the fermenting system of FIG. 4A;

FIG. 5A is a side elevation view of a fermenting system constructed in accordance with another embodiment of the invention;

FIG. 5B is a side elevation view of the fermenting system of FIG. 5A;

FIG. 5C is a side elevation view of the fermenting system of FIG. 5A;

FIG. 5D is a side elevation view of the fermenting system of FIG. 5A;

FIG. 5E is a schematic diagram depicting fermenting systems operating in parallel;

FIG. 6 is a chart depicting certain data pertaining to the present invention;

FIG. 7 is a chart depicting certain data pertaining to the present invention;

FIG. 8A is a chart depicting certain data pertaining to the present invention;

FIG. 8B is a side elevation view of an embodiment of the present invention;

FIG. 9 is a schematic diagram of a waste system constructed in accordance with an embodiment of the present invention;

FIG. 10 is a schematic diagram of a waste system constructed in accordance with an embodiment of the present invention;

FIG. 11 is a schematic diagram of a waste system constructed in accordance with an embodiment of the present invention;

FIG. 12 is a schematic diagram of a waste system constructed in accordance with an embodiment of the present invention;

FIG. 13 is a schematic of an airlock decant mechanisms;

FIG. 14 is a schematic of a submerged partial baffle; and

FIG. 15 is a two stage fermentation system for fermentation and granule formation in an activated sludge process.

### DETAILED DESCRIPTION

During fermentation, complex organic compounds in the wastewater solids are broken down into simpler compounds, with VFAs being one of the key byproducts. Acetic acid, propionic acid, butyric acid and valeric (and their isomers) are common VFAs produced in this process. In this invention, these VFAs can then be extracted from the fermenter effluent and further processed for various applications including for biological nutrient removal (such as but not limited to enhanced biological phosphorus removal and for all forms of denitrification). Specific processes characterized in this invention as an embodiment include storage processes coupled with denitrification using any internal or external storage polymer including but not limited to glycogen, poly hydroxy alkanoate, extracellular polymers, and for reactions such as but not limited to pre-denitrification, post-denitrification or for partial denitrification and anammox (PdNA). Such storage and reactions are beneficial to reducing greenhouse gases (specifically methane, N₂O and CO₂) and to reducing air/oxygen and carbon requirements.

The utilization of fermenters for VFA production, as an embodiment, from primary/raw sludge/solids or food waste aligns with the principles of circular economy and sustainable wastewater management. It not only helps in reducing the environmental impact of sludge management but also provides an opportunity to harness valuable organic compounds for beneficial reuse. Additionally, the VFAs generated from this process can serve as a renewable and cost-effective feedstock for the production of bio-based chemicals and bioenergy, contributing to the overall sustainability of wastewater treatment operations. The terms labile COD, VFA and rbCOD and floc filtered COD (where floc filtered COD and rbCOD have established measurement methods in literature) can be used interchangeably.

A variety of different fermenter configurations have been developed for VFA recovery for nutrient removal at wastewater treatment plants. The fermenter vessel can be an independent unit or part of a larger tank where baffles and partitions isolate a space and said space is used as a fermenter. A 2019 review from the Water Research Foundation, Fermenters for Biological Phosphorus Removal Carbon Augmentation, herein incorporated by reference, summarizes the current state of the art. Five main systems are identified therein for producing VFA, namely, the Activated Primary Sedimentation tank, the Complete Mixed Fermenter, the Single-Stage Static Fermenter/Thickener, the Two-Stage Mixed Fermenter/Thickener, and the Unified Fermentation and Thickening (UFAT) Fermenter.

In this invention, elutriation is used to both reduce inhibition (from the product) and collect and transport the VFA formed during the wastewater solids fermentation stage once the fermentation has taken place. This provides both a collection and transport mechanism and acontrol of inhibitory conditions due to the VFA produced that arise during fermentation. The elutriation ameliorates the inhibition from VFA produced during fermentation, by moderating the decrease in pH and the formation of inhibitory unionized volatile fatty acids. the elutriation improves bacterial reactions that limit the rate and yield of VFA that can be produced by shifting the pKa towards ionized and less inhibitory products. Optimizing the rate and yield of VFA production and recovery contribute to the economics of wastewater treatment operation and the decarbonization (reducing aeration energy as well as direct greenhouse gas emissions) of the process by substituting external chemical supplies and reducing transportation costs and from fossil carbon sources. In addition to the ameliorating the product inhibition effect, managing the conditions during fermentation will also help sequester or preferably manage the leakage of phosphorus captured in the sludge back into the wastewater liquid stream. Plants with strict phosphorus limits usually find that the leakage of P during fermentation can be excessive and preclude the use of fermenters. Furthermore, formation of odorous compounds in fermenters might become another precluding factor for the use of fermenters due to the cost of collecting and treatment of gases emanating from the units. In an embodiment, micro-aeration/fractional aeration with oxidation reduction potential (ORP) or aeration time control helps control the formation of odorous compounds and enhances hydrolysis (this term includes enzymic processes as well as particle destruction/breakdown) of particulates in the sludge further improving stoichiometry (through pH and ORP modulation/moderation), kinetics (reducing the time needed for degradation) and extent (degradation of hard to degrade compounds or feedback inhibited) of the fermentation reaction. In an embodiment, micro-aeration or fractional aeration is an approach to manage the ORP, dissolved oxygen or oxidation state of the solids. From an apparatus/system perspective, micro-aeration or fractional aeration improves the hydraulics by sufficiently lifting sludge or liquids within existing retrofits in ‘tight’ hydraulic grades where hydraulic head may not be available and to thus address both process requirements and tankage (especially tanks in series approach) configuration.

Turning to FIG. 1, an intensified fermentation reactor 100 and system (inFERMx) will now be described in more detail. The intensified fermentation reactor 100 is a customizable, standalone equipment package in part or whole that can be deployed at various points within a plant's wastewater or sludge processing flow to replace or augment existing process equipment such as gravity thickeners, sludge equalization (EQ) tanks, primary filter backwash settling tanks, primary tanks or even parts or entirety of a sewer system. The intensified fermentation reactor 100 may improve the state of the art in several key manners by incorporating several stages into a single, unified system for operation and control. In particular, the intensified fermentation reactor 100 broadly (i.e. not all elements are needed in every implementation) comprises several stages including a microscreen stage 102, a pre-conditioning stage 104, a micro-aeration/fractional aeration stage 106, and an elutriation stage 108. The intensified fermentation reactor 100 where applicable, also includes instrumentation and control 110.

The microscreen stage 102 provides sludge strain press or like for biosolids improvements. The microscreen stage 102 filters rags, screening material, and inert matter, which thereby produces better digestion efficiency, lower solids production rates, and improved biosolids quality. Any carbonaceous material (such as cellulosic substances) extracted from stage 102 could be optionally subject to preconditioning as needed for increasing fermenter yields.

The pre-conditioning stage 104 physically, chemically or biologically conditions particulate streams for fermentation. This may increase fermentation rates or yields by 25% to 50%. A physical preconditioner could be a macerator or a mill or a device that increases particle surface area for downstream hydrolytic reactions. This physical preconditioner in one embodiment can be combined with a pump, such as a chopper pump. In one embodiment, the physical preconditioner is an added material such as fine inert particles or filings used to break up particles that is then recovered gravimetrically using a screen or hydrocyclone or any form of classifier (here the term gravimetric refers to the selective classification achieved by gravity forces due to a sludge volume index metric). A chemical preconditioner can be any chemical including and not limited to an oxidant, reductant, acid, base, deflocculator, charged material, ensbile, or such, that can improve the enzymatic reaction rates or particle disintegration. A biological preconditioner is any biological substance or enzymes or cofactors that are produced from a biological substance (a microorganism, eukaryote (including for example natural or synthesized products that are similar or thereabouts equivalent to those found in rumen's stomachs that either breakdown particles or improve downstream reactions by microorganisms. These preconditioners could be in series, parallel, circular, or occur in the same stage. In a form of biomimicry, such as in a eukaryote (especially a rumen), where teeth break up particles from chewing and the stomach chemically or biologically conditions the particles, and these may go back to the teeth for further chewing). The preconditioner can be at a higher temperature and could be seeded with organisms (such as C. bescii or any organism that more thoroughly improves hydrolysis) that help breakdown lignocellulose or a specific constituent in the influent to the fermenter. The preconditioner may also simply improve viscosity and thus allow for intermixing of particles with the conditioners that breakdown the particles. The preconditioner could be operated at a higher temperature including and not limited to a thermal preconditioner. The preconditioner could be operated at both a higher pressure and temperature such as to soften the particles. The preconditioner could be steam or waste steam from any process. The preconditioner could be a small pyrolyzer. The use of such preconditioners could be at any solids concentration and for any waste or virgin material. The preconditioner could be looped with the fermentation unit where a recirculation stream from a fermenter helps with the preconditioning and overall hydrolysis and fermentation.

The micro-aeration/fractional aeration (or addition of substances with a higher oxidation state) stage 106 activates or kinetically accelerates the fermentation process. Micro-aeration or fractional aeration in AAA primary treatment processes may increase the net yield of fermentation without substantial conversion (i.e. only 5% to 15%) of the influent COD carbon to CO₂.

The elutriation stage 108 enables enhanced elutriation and the minimization of product inhibition of soluble COD rich streams to redirect to biological nutrient removal processes. In thickening or AAA fermentation processes, the concentration of soluble COD can build in the settled sludge blanket. This can begin to limit additional soluble COD production, which is the needed ingredient for nutrient removal. Effecting feedback control approaches to ensure that the biological processes are not inhibited kinetically and stochiometrically is a novel embodiment.

The instrumentation and control 110 applies to fermentation reactor components. The inFERMx process may incorporate SENTRY sensors (or any form of microbial sensors) or other direct or indirect sensors, including soft sensors for measuring the fermentate yield, which enables control of pre-treatment, micro-aeration/fractional aeration, and elutriation. This may provide the ability to balance the soluble COD production to meet the exact nutrient removal needs, ensuring that the maximum amount of COD is diverted to biogas production while still maintaining effluent limits. The elutriation can occur in any or multiple vector direction, along a horizontal, vertical or incline.

Each of the above stages or components has an increment of improvement on the overall hydrolysis/fermentation system/process, but the combination thereof into a single, and if desired, controllable system has not been heretofore accomplished and provides several areas of novelty. In particular, the intensified fermentation reactor 100 and associated method decouples hydraulic retention time (HRT) and solids retention time (SRT) for increased or more concentrated volatile fatty acids (VFA) production while minimizing tank volume and footprint, thus reducing the embedded carbon footprint of civil works. Control of the process, if desired, is also greatly improved, since VFA dosing can be tuned to diurnal carbon demand without sacrificing optimal solids residence time in the sludge blanket. The present invention also reduces odor and corrosion using micro-aeration/fractional aeration if desired, which prevents the emission of H₂S, methane, and other odoriferous compounds that are products of deep anaerobic conditions. The present invention also maximizes fermentative enzyme production and VFA yield through micro-aeration/fractional aeration-based bacterial community forcing (encouraging growth of facultative anaerobes) and optimized feedstock dosing (feeding high-carbon primary sludge or food waste). The present invention also avoids wasted aeration energy through time-optimized carbon dosing made possible by online BCE sensor monitoring and controls. The present invention also allows plants to automatically react in real time to ammonia loading peaks with carbon addition from fermentation and avoid feeding fermentation products when denitrification carbon demand is low. The present invention further prevents kinetic/pH limitation of the fermentation rate through elutriation (active export of VFAs). The present invention also provides standardized design and optimized fit-for-purpose equipment selection, which reduces implementation costs and avoids operational headaches.

The intensified fermentation reactor 100 optimizes fermentation of particulate COD to best balance the carbon footprint for wastewater and wet waste between energy production, energy consumption, nutrient removal, and biosolids production while minimizing footprint. The intensified fermentation reactor 100 could be configured for the municipal wastewater market for primary treatment, biological/secondary treatment, primary sludge fermentation (inFERMp), return activated sludge (inFERMr), or a combination thereof (inFERMpr) or foodwaste fermentation. Importantly, the intensified fermentation reactor 100 could also be used by digestion facilities, including some Water Resource Recovery Facilities (WRRFs) that process source-separated organics (SSOs) or food waste, or industrial food processing pretreatment applications (inFERMi) in which biogas production could be optimized at the Source-Separated Organics (SSO) or food processing site, while still discharging a controlled amount of soluble COD to aid in biological treatment at downstream municipal water resource recovery facilities to reduce chemical addition, external carbon addition, and N₂O emissions in any pathway, including and not limited to the denitrification pathway associated with biological nutrient removal.

The intensified fermentation process of the present invention delivers optimal and efficient “fit for purpose” carbon management at WRRFs that remove nutrients from wastewater while optimizing carbon redirection. Adoption of intensified fermentation in one embodiment reduces Scope 1 and Scope 3 greenhouse gas (GHG) emissions by mitigating N₂O and/or methane emissions within the treatment process, replacing external organic carbon electron donor requirements with in-situ production. This reduces the use of metal salts, increases controlled biomethane production to replace fossil fuel energy requirements, reduces biosolids production and exports to landfills or land application, and reduces the discharge of nutrients into the aquatic environment, which contribute to eutrophication-related GHG emissions. Scope 2 reductions may also be facilitated through greater enablement of APT carbon redirection strategies.

The intensified fermentation process is controllable and maximizes the beneficial uses of particulate COD in wastewater. Each stage in the intensified fermentation process has been independently validated at scales ranging from benchtop to demonstration scale. The combination and integration of each piece of equipment provides the first opportunity to leverage the emergent and synergistic benefits of combining the stages of sludge conditioning (screening, preconditioning, micro-aeration/fractional aeration, and elutriation) into a single process element with advanced controls and plant-scale feedback. By embedding the inFERMx equipment at WRRFs with advanced primary treatment, the full benefit of intensified fermentation can be demonstrated on sludges rich in diverted carbon for the first time. This has the potential to drive adoption of advanced primary carbon diversion strategies which may not be feasible without co-adoption of intensified fermentation.

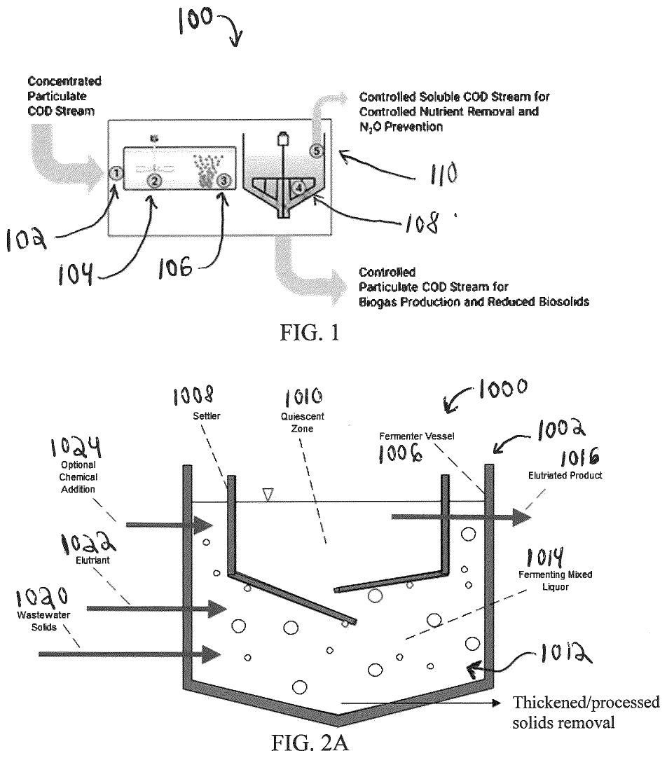

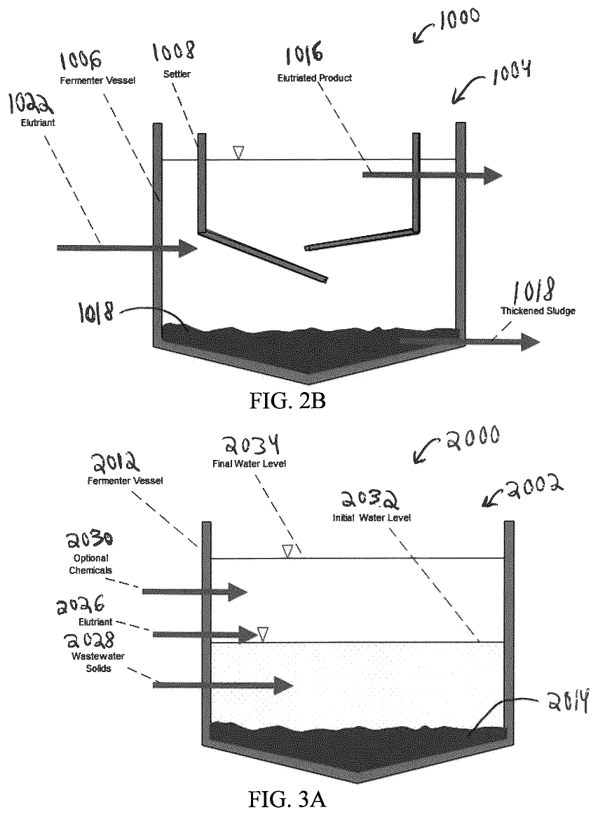

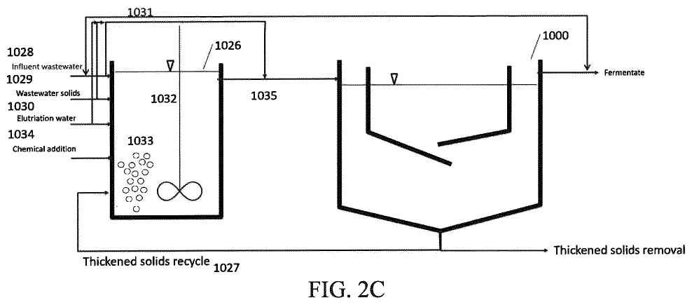

Turning to FIGS. 2A, 2B, and 2C a fermenting system 1000 will now be described. The system includes a sequential operation cycle having a first stage 1002 (FIG. 2A) and a second stage 1004 (FIG. 2B). The first stage 1002 is a feeding (adding wastewater solids), fermentation and elutriation stage, whereas the second stage 1004 is an elutriation-settling and wasting (sludge removal) stage. The system 1000 comprises a fermenter vessel 1006, which may be an independent unit or part of a larger tank in which baffles and partitions isolate a space in the larger tank to be used as a fermenter. The fermenter vessel 1006 may include a settler 1008 (also referred to as an internal clarifier, or as a decanter, where mixing is limited) having a set of partitions to form a quiescent zone 1010 and a fermentation zone 1012 external from the settler 1008. Fermenting mixed liquor 1014 is conveyed to the quiescent zone 1010 where settling of sludge is allowed to occur forming a clarified liquid (elutriated product 1016) and a settled sludge 1018. Return of the settled sludge 1018 back to a main fermenter vessel may take place by gravity or by induced water movement, and the elutriated product 1016 may be collected and removed. The fermenter vessel 1006 may also have means for receiving a series of inputs (adding to the system), such as but not limited to wastewater solids 1020, elutriant 1022, and optionally chemicals 1024. The wastewater solids itself could be an elutriant and in one embodiment is added along the bottom of a tank using a series of feed pipes. The fermentation zone 1012 may have means for mixing and keeping the sludge in the fermenting mixed liquor 1014 in suspension as needed. In some embodiments mixing is conducted using coarse bubble or bubble guns, while in other embodiments mixing is conducted by hydraulic means, such as but not limited to a recirculating stream, and yet in other embodiments mixing is conducted using propellers, or other mixing devices. The fermentation zone 1012 may also have an optional pH control subsystem to add an acid or a base as needed for controlling pH at a desired range or set point. In some embodiments the ORP of the fermentation zone 1012 may be controlled by acting on the aeration for mixing. When using aeration for mixing the quiescent zone 1010, the settler 1008 may divert the bubbles in the fermentation zone 1012 away from the quiescent zone 1010. The fermenter vessel 1006 may also be configured to control mixing and may include valves for controlling the input and output of flows to the system 1000. Timing of the inputs of wastewater solids 1020, elutriant 1022, and chemicals 1024 may all be under control of the operator.

In more detail, FIG. 2A illustrates the first stage 1002 in which wastewater solids 1020 (which itself may be an elutriant), optional elutriant 1022, and chemicals 1024 are coming into the fermenter vessel 1006 and the elutriated product 1016 is removed. FIG. 2B on the other hand illustrates the second stage 1004 in which mixing has been turned off allowing the sludge in the fermenting mixed liquor 1014 to settle and thicken. Thickened sludge 1018 is removed from the fermenter vessel 1006 and elutriation of the settled product is still taking place. Removal of sludge in this and any other embodiment of the present invention may take place with a variety of pumps or hydraulic devices, such as but not limited to air lift pumps, or positive displacement pumps. Removed sludge 1018 can be redirected to a variety of locations in the plant as needed for a particular application. Running the system 1000 from the first stage 1002 (feeding-elutriation-fermentation), as shown in FIG. 2A, to the second stage 1004 (elutriation-settling-wasting), as shown in FIG. 2B, achieves the objectives of continuous removal of fermentation products to reduce product inhibition, optional pH control to further optimize inhibition relief, optional addition of chemicals for P leakage control, ORP control for hydrolysis enhancement, and odor control and fermentation solids retention time (SRT) control. The time length and frequency of each cycle or individual stages may be fully controlled by the operator of the system 1000, thus enabling further optimization to local conditions. The first stage 1002 and second stage 1004 can be flipped if so desired and an airlift pump can send sludge ‘upstream’ between the two stages for further processing. Furthermore, feed and elutriation may be combined in a single cycle in a near constant water level reaction, where the feed displaces the effluent (in a contact stabilization approach) and where the reaction (or stabilization) step precedes this contact step. In the contact step, the particles are trapped in a blanket, while the produced VFA is elutriated. The sludge is then sent to upstream step for further reaction and hydrolysis using micro-aeration or fractional aeration. The contact stabilization approach can be performed in series or sequential approaches in any format-including and not limited to a primary, anaerobic zone of secondary, or gravity thickener or an acid digester.

A continuous flow configuration introduces an upstream reactor vessel 1024 where pre-conditioning with mixing and/or micro-aeration occurs (FIG. 2C). In this configuration, thickened solids 1027 are recycled from the fermentation vessel 1000 to the pre-conditioning vessel 1026. In addition, raw wastewater 1028, wastewater solids 2019, and/or elutriation water 1030 can be added to the pre-conditioning reactor. An additional iteration would recycle fementate effluent 1031 from the fermentation vessel 1000 to pre-conditioning vessel 1026. In the pre-conditioning vessel 1026 mixing 1032 and/or micro-aeration 1033 are applied to achieve preconditioning of the wastewater solids. This is the same as the processes described in FIG. 2A with the exception that the processes are occurring in a separate vessel upstream of the fermentation vessel. Chemical may also be added to this pre-conditioning vessel 1034 to create conditions that will enhance fermentation rates and efficiency in the downstream reactor 1000. Flow from the pre-conditioning vessel flow to the fermentation vessel 1034. A portion or all of the flows into the preconditioning vessel can be directed around the pre-conditioning reactor to the fermentation reactor. The recycle rate of solids 1027 and the feed of solids into the pre-conditioning step 1028, 1029, and 1031 as well as chemical addition 1030 maybe all be controlled by either direct measurement of ORP or COD in the fermentate, an indicator measurement in the fermentate, or a soft sensor application in the fermentate. The present invention includes the embodiment of these various components in pre-conditioning vessel upstream of a fermentation vessel.

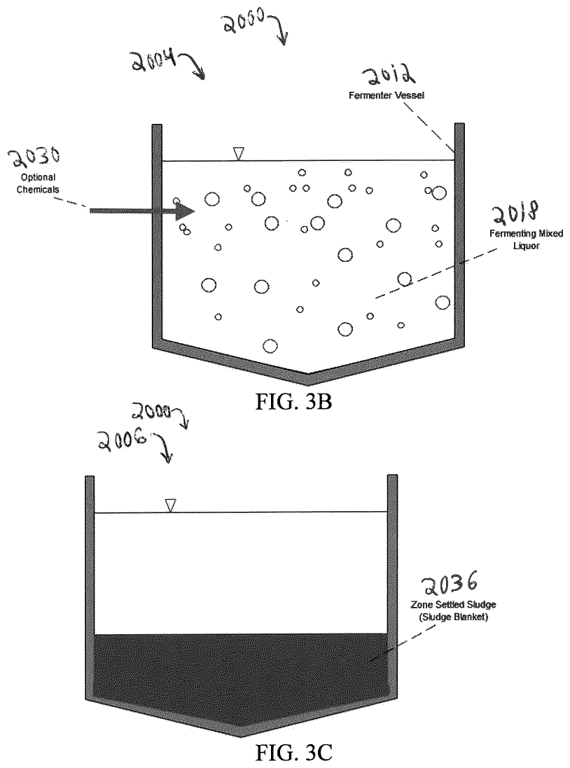

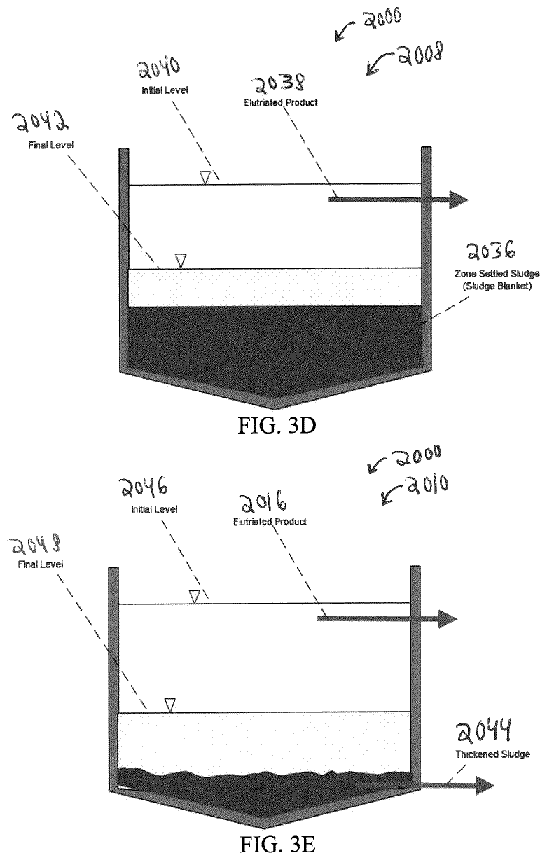

Turning to FIGS. 3A-E, another fermenting system 2000 will now be described. The system 2000 includes several stages and in particular, a feeding stage 2002 (FIG. 3A), an active fermentation stage 2004 (FIG. 3B) that can consist of micro-aeration or fractional aeration, a settling stage 2006 (FIG. 3C), a withdrawal stage 2008 (FIG. 3D), and a wasting stage 2010 (FIG. 3D). The system 2000 is similar to the system 1000 described above except the fermenter vessel 2012 does not include an internal setter-decanter-clarifier dedicated quiescent zone. Instead, the system 2000 is configured to achieve settling and clarification to separate sludge 2014 from the elutriated product 2016 by turning off mixing and/or aeration in the fermenter vessel 2012 allowing the sludge 2014 in fermenting mixed liquor 2018 to settle, thereby inducing the formation of a clarified zone 2020 and a zone settling interphase 2022 (also referred to as a sludge blanket). Removal of the clarified liquid to form the elutriated product 2016 from the clarified zone 2020 is then activated. In this embodiment, a water level in the fermenter vessel 2012 is allowed to fluctuate down when removing the elutriated product 2016 and/or removing the thickened sludge 2014 for wasting, and fluctuate up when adding elutriant 2026 or fresh wastewater solids 2028 for feeding the fermenter vessel 2012. To that point, the fermenter vessel 2012 is equipped with means for removing the clarified liquid (to form the elutriated product 2016) from different levels within the fermenter vessel 2012. This can be achieved by one of a variety of hydraulic devices such as but not limited to floating overflows, basculating overflows, or telescopic valves.

FIG. 3A illustrates the feeding stage 2002, in which mixing is turned off, sludge 2014 has been allowed to settle and thicken, and the water level 2024 is low, indicated in FIG. 3A as initial water level 2032, and elutriant 2026 is added and/or wastewater solids 2028 is added for feeding and, optionally, chemicals 2030 are added for different objectives such as but not limited to pH control and/or control of phosphorus leakage from the sludge 2014 to the elutriated product 2016. No withdrawal of elutriated product 2016 is illustrated in the feeding stage 2002. Addition of elutriant 2026 dilutes the contents of the fermenter vessel 2012, which helps reduce toxicity during fermentation. Feeding, or addition of fresh wastewater solids 2028, continues until the fermenter vessel 2012 water level reaches a specified final water level 2034. Mixing and aeration can be turned on in the feeding stage 2002 as no withdrawal of elutriated liquid is taking place.

FIG. 3B illustrates the active fermentation stage 2004 where chemicals may be added as needed for pH control (such as an alkali or a chemical that provides sufficient inorganic carbon) or other objectives, and mixing and optionally aeration may take place. In the active fermentation stage 2004, increasing and decreasing aeration may be performed optionally for ORP control or while measuring carbon/COD production using a analyzer or soft sensor (a series of measurements that provide an indirect estimate of carbon). This will further enhance hydrolysis of wastewater solids and reduce formation of odorous reduced sulfur compounds.

FIG. 3C illustrates the settling stage 2006 in which mixing and/or aeration is turned off and a sludge blanket 2036 forms. Once the sludge blanket 2036 is formed withdrawal of clarified liquid can take place from the surface of the fermenter vessel 2012.

FIG. 3D illustrates the withdrawal stage 2006 in which the clarified liquid is withdrawn as elutriated product 2038 after the sludge blanket 2036 is formed. The water level is allowed to decrease within the vessel from a high initial level 2040 to a low final level 2042. Notice that no sludge withdrawal takes place in this step as the sludge blanket 2036 is not allowed to fully thicken. However, removal of sludge in this stage may be activated as needed. The main purpose of this step is to withdraw elutriated product 2038, thus enabling removal of toxic product inhibitors. After this withdrawal stage 2006, mixing may be turned back on and filling of the fermenter vessel 2012 with fresh elutriant may take place in a similar way as in the feeding stage 2002. Similarly, optional feeding of wastewater solids could take place. Dilution by adding fresh elutriant, active fermentation, and withdrawal of elutriated product could also be repeated.

FIG. 3E illustrates the wasting stage 2010. This stage is similar to the withdrawal stage 2006 of FIG. 3D with the difference that the sludge is allowed to settle to compression forming a thickened bottom layer that is withdrawn as thickened sludge 2044 and wasted from the fermenter vessel 2012, optionally removal of sludge could take place with partially thickened sludge as during elutriation or immediately after. Note that a water level is allowed to decrease from an initial water level 2046 to a lower final water level 2048 in this stage. Because the thickening process is considerably longer than the sludge blanket formation, the wasting stage 2010 is repeated at a low frequency-only when needed to remove sludge from the system 2000. This enables accurate control of the SRT as needed. Removal of sludge in this and any other embodiment of the present invention may take place with a variety of pumps or hydraulic devices, such as but not limited to air lift pumps, or positive displacement pumps. Removed sludge can be redirected to a variety of locations in the plant as needed for the application. The overall cycle of operation enables rapid exchanges of elutriant to remove toxic inhibitory products from fermentation enhancing reaction rates and yields, control of phosphorus leakage and thickening of the waste sludge.

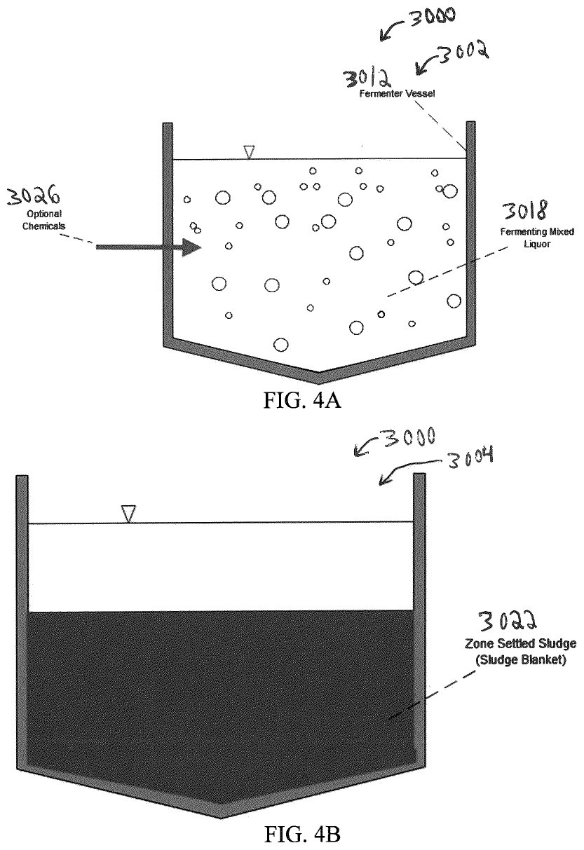

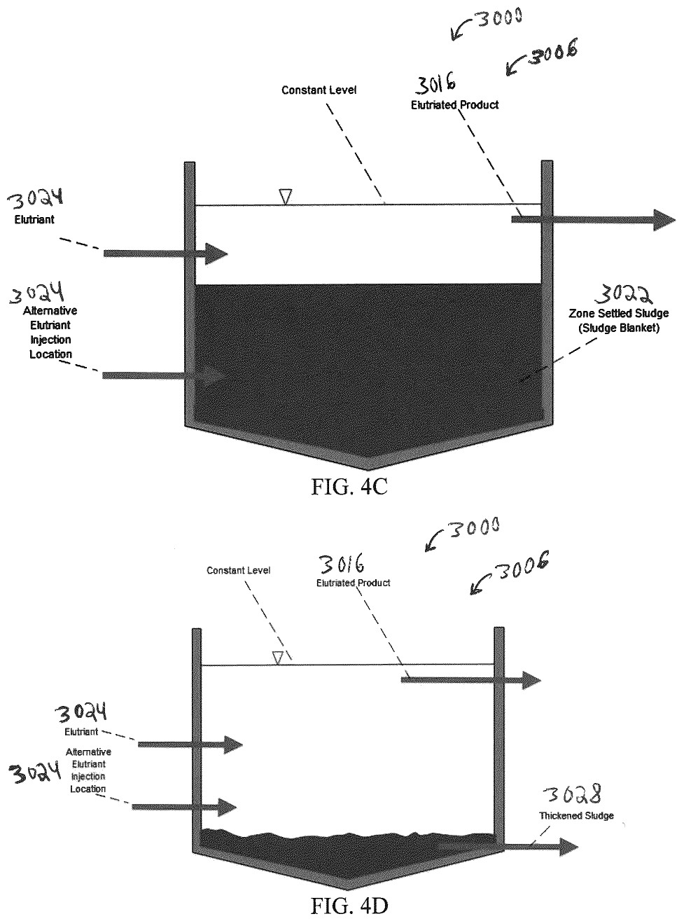

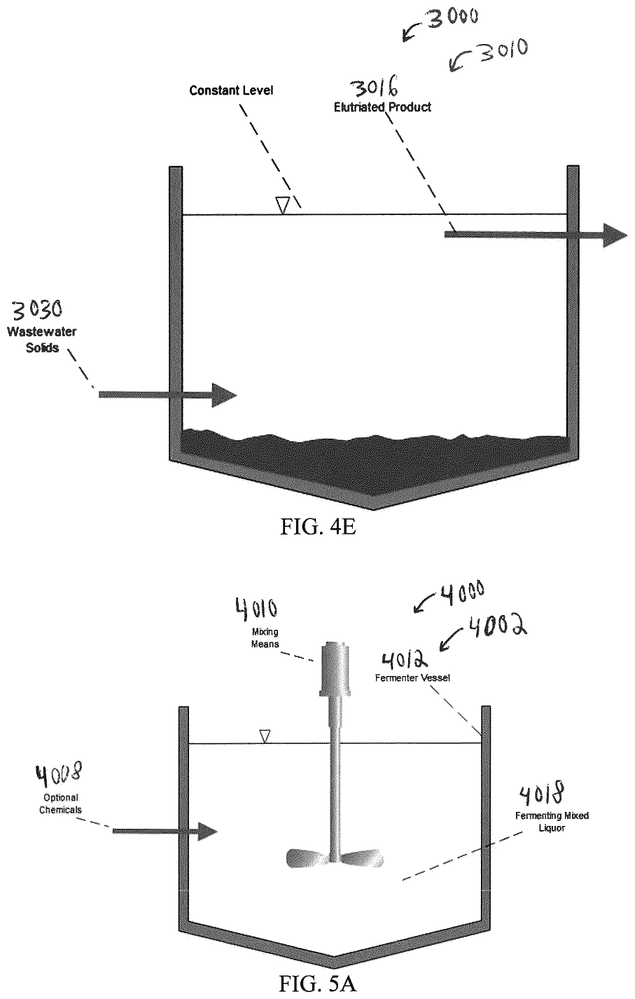

Turning to FIG. 4A-4E, another fermenting system 3000 will now be described in more detail. The system 3000 includes several stages and in particular, a fermentation stage 3002 (FIG. 4A), a settling stage 3004 (FIG. 4B), an elutriation stage 3006 (FIGS. 4C and 4D), and a wasting stage 3010 (FIG. 4E). This embodiment is similar to system 2000 in that no internal setter-decanter-clarifier dedicated quiescent zone is created, but the settling effect to separate sludge from the elutriated product 3016 happens by turning off mixing in the fermenter vessel 3012. This allows sludge in the fermenting mixed liquor 3018 to settle in the fermenter vessel 3012, thus inducing a sludge blanket 3022. This system 3000 is similar to the previous system 2000 in the sense that no internal dedicated quiescent zone exists, except in system 3000, the water level within the fermenter vessel 3012 is not allowed to fluctuate up and down. The water level remains relatively constant, which simplifies the hydraulic withdrawal mechanism for withdrawing the clarified liquid in the form of elutriated product 3016. However, the introduction of the elutriant 3024 (applicable for thickened streams, and use of wastewater influent is sufficient for primary or anaerobic zone of secondary) in this case requires a more sophisticated flow distribution and precise location to achieve a sweeping effect of slow-moving water from the bottom of the tank to the surface.

FIG. 4A illustrates the fermentation stage 3004, in which mixing and/or aeration is turned on and fermentation actively takes place forming products. Chemicals 3026 are optionally added to control fermentation conditions such as but not limited to pH and leakage of phosphorus to the liquid from the sludge. ORP is also optionally controlled by controlling aeration, microaerophilic conditions are desirable to enhance hydrolysis of wastewater solids particles while minimizing the oxidation of the VFA. If an alkali is added, it may help improve fermentation as well as improve inorganic carbon to limit the formation of N2O in downstream processes, not shown in figure. Micro-aeration or fractional aeration can be added during the fermentation step in the cycle.

FIG. 4B further illustrates settling stage 3004 with the formation of the sludge blanket 3022 in the fermenter vessel 3012 by turning off mixing and/or aeration. The clarified liquid on top of the sludge blanket 3022 can now be swept to the effluent forming the elutriated product 3016 by distributing the elutriant flow on the bottom of the fermenter vessel 3012 to avoid short circuiting and adding dilution water. The clarified liquid at the top overflows as the elutriant 3024 is introduced in the lower parts of the fermenter vessel 3012.

FIG. 4C illustrates the elutriation stage 3006 by the introduction of the elutriant 3024 in the lower parts of the fermenter vessel 3012 (needed in the case of thickened sludge). An oxidant may be added along with the elutriant to freshen the sludge. Several injection locations might be provided depending on the geometry of the fermenter vessel 3012. It is important to avoid short circuiting and elutriant flow distribution is carefully carried out. FIG. 4C illustrates alternative locations for flow distribution of the elutriant flow. In this embodiment, the water level of the fermenter vessel 3012 remains constant, and the elutriated product 3016 is collected by overflow at the water surface of the fermenter vessel 3012. Notice that in FIG. 4C no removal of sludge takes place as the sludge blanket 3022 is not thickening enough to withdraw the sludge, however, the ability to remove thickened sludge in this step is not precluded and removal may take place during this step or immediately after. The sequence of fermentation/settling/elutriation may be repeated with relative frequency to remove the inhibitory fermentation products formed during sludge fermentation. The combination of frequent elutriation with pH and phosphorus leakage control provides significant improvement to the process enhancing fermentation rates and yields. Sludge withdrawal for wasting takes place when the settling sequence is extended in time allowing the sludge in the sludge blanket 3022 to reach higher solids concentrations, at which time the thickened sludge at the bottom of the fermenter vessel 3012 is removed. The duration of the enhanced thickening for removal of thickened sludge may vary in time as needed to optimally operate the process. Removal of sludge in this embodiment, as with the other embodiments, may take place with a variety of pumps or hydraulic devices, such as but not limited to air lift pumps, or positive displacement pumps. Removed sludge can be redirected to a variety of locations in the plant as needed for the particular application.

FIG. 4D is similar to FIG. 4C but illustrates the lower level of sludge due to the higher concentration of thickened sludge 3028. Elutriation is still taking place along with sludge withdrawal of thickened sludge. Elutriation is then stopped, and fresh sludge 3030 is fed to the system to replace the wasted material and control of SRT, as shown in FIG. 4E. That is, FIG. 4E illustrates feeding or addition of fresh sludge 3030 with overflow of the elutriated product 3016. Once the system 3000 receives the fresh sludge 3030, mixing is turned on along with optional aeration, COD analysis (using any sensor approach, such as UV/Vis, microbial sensor, respirometer, soft sensor) control, ORP control and pH control, and the cycle starts once again.

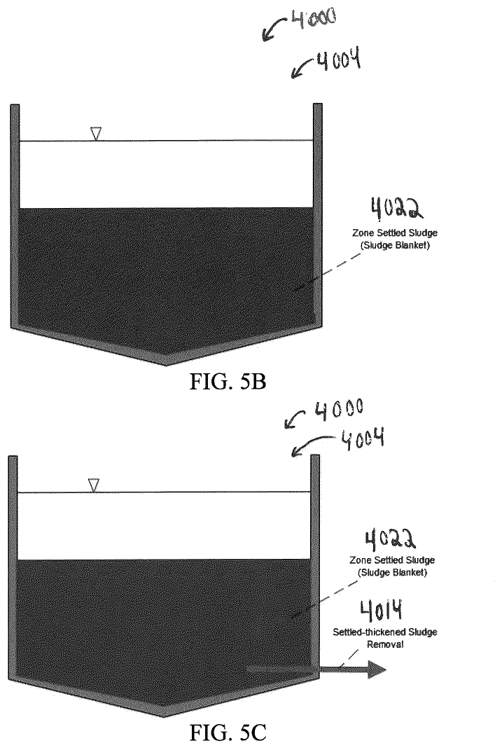

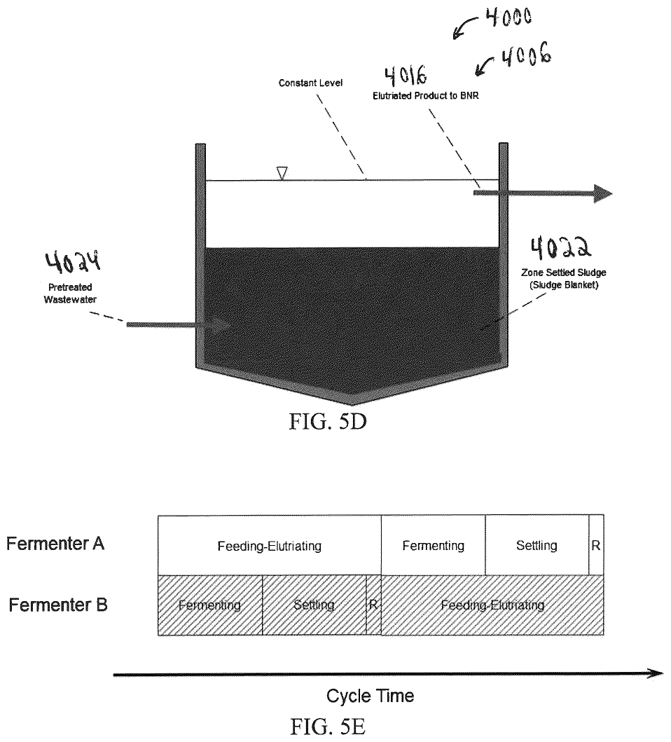

Turning to FIG. 5A-5E, another fermenting system 4000 will now be described. The system 4000 includes several stages and in particular, a fermentation stage 4002 (FIG. 5A), a settling stage 4004 (FIGS. 5B and 5C), and a feeding/elutriation stage 4006 (FIG. 5D). The system 4000 is similar to system 3000 in that no internal setter-decanter-clarifier dedicated quiescent zone is created, but the settling effect to separate sludge from the elutriated product 4016 is achieved by turning off mixing in the fermenter vessel 4012. This allows the sludge in the fermenting mixed liquor 4018 to settle in the fermenter vessel 4012, thereby inducing the formation of a sludge blanket 4022. In this embodiment, the fermenter vessel 4012 is a primary clarifier or an anaerobic selector and the elutriant 4024 is pretreated wastewater such as but not limited to degritted influent wastewater, or screened and degritted wastewater, or wastewater after removal of floatables, or wastewater that is directed to a primary treatment or a biological treatment. Because the elutriant contains particulate organics that can be subject to hydrolysis and fermentation, no separate addition of wastewater solids and elutriant takes place but elutriant and fermentable organics are added in a combined way. FIG. 5A to FIG. 5D are similar to the previous series of FIG. 4A to FIG. 4D in the sense that no internal dedicated quiescent zone exists and a fixed water level for decanting of effluent is used. The approach as depicted in FIG. 5A to FIG. 5D can be implemented in any format including, a primary tank (such as the AAA settler), an anaerobic zone of a secondary tank, a gravity thickener, an acid digester, or a RAS fermentation tank. The water level remains constant, which simplifies the hydraulic withdrawal mechanism of the clarified liquid, elutriated product. However, the introduction of an optional freshening elutriant 4024 is applied in the case of thickened flows (in a gravity thickener or acid digester) sometimes along with an oxidant (such as permanganate or chlorine/hypochlorite) in this case requires a more sophisticated flow distribution and precise location to achieve a sweeping effect of slow-moving water from the bottom of the tank to the surface. If an alkali is added, it may help improve fermentation as well as improve inorganic carbon to limit the formation of N2O in downstream processes, not shown in figure.

FIG. 5A illustrates the fermentation stage 4002 wherein mixing and/or micro-aeration/fractional aeration is turned on via mixer 4010 and fermentation actively takes place forming products. Chemicals 4008 are optionally added to control fermentation conditions such as but not limited to pH or leakage of phosphorus to the liquid from the sludge. ORP is also optionally controlled by controlling aeration, microaerophilic conditions are desirable to enhance hydrolysis of wastewater solids particles without oxidizing the VFA or rbCOD. The operation of micro-aeration (such as DO and ORP values) and fractional aeration (5% to 20% of hydraulic retention time) has been previously described and the readily biodegradable COD and CO2 generated is also previously described.

FIG. 5B further illustrates settling stage 4004 with the formation of the sludge blanket 4022 in the fermenter vessel 4012 by turning off mixing including any mixing provided by micro-aeration/fractional aeration if used. The clarified liquid on top of the sludge blanket 4022 can now be swept to the effluent forming the elutriated product 4016 by distributing the elutriant flow on the bottom of the unit to avoid short circuiting and adding dilution water. the clarified liquid at the top overflows as the elutriant 4024 is introduced in the lower parts of the fermenter vessel 4012.

FIG. 5C illustrates the removal of excess sludge from the sludge blanket 4022 of the fermenter vessel 4012. In some cases, removal of sludge from the sludge blanket 4022 is conducted after initial settling, yet in other cases settling is extended to enable further thickening and removal of thickened sludge 4014. The thickened sludge concentration can range from 3% to 12% depending on desired thickness for downstream processing (i.e. the increase in thickening can range from a 0 percent point increase to a 10 percent points increase). The approach can be operated at a higher temperature such as by introducing heat or steam (including as a preconditioner), or by using autothermal conditions that arise from micro-aeration using pure oxygen or from effective heat management. The higher temperature allows for reduction in viscosity and for improved thickening of sludge. The temperature can be operated to 78 degrees Celsius or any temperature below the gelation of sludge and the denaturing of proteins to form such viscous gels. Removal of sludge in this and any other embodiment of the present invention may take place with a variety of pumps or hydraulic devices, such as but not limited to air lift pumps, or positive displacement pumps. Removed sludge can be redirected to a variety of locations in the plant as needed for the particular application.

FIG. 5D illustrates the feeding/elutriation stage 4006 by the introduction of the elutriant 4024 (such as wastewater or pretreated wastewater depending on process format) in the lower parts of the fermenter vessel 4012 within the sludge blanket 4022 to induce contact of the wastewater with the sludge blanket 4022 promoting the sorption of small particulates within the blanket. Several injection locations might be provided depending on the geometry of the fermenter vessel 4012. It is important to avoid short circuiting and elutriant flow (pretreated wastewater), so distribution thereof is carefully carried out. The water level of the fermenter vessel 4012 remains constant, and the elutriated product 4016 is collected by overflow at the water surface of the fermenter vessel 4012 and directed to a BNR process downstream. The combination of frequent elutriation with pH and phosphorus leakage control provides significant improvement to the process enhancing fermentation rates and yields. Integration of higher yields with the BNR process downstream further optimize the overall plant performance. Using the wastewater or pretreated wastewater as elutriant 4024 and having the cycles presented previously in FIG. 5A to 5D is part of this embodiment. During those cycles where no feeding of the fermenter vessel 4012 is taking place (fermenting (which may include micro-aeration or fractional aeration), settling and in some cases sludge removal) wastewater continuously flows to the plant is redirected from the fermenter vessel 4012. In some embodiments the redirected wastewater can be conveyed to a conventional parallel train with the plant. In other cases, the redirected wastewater can be optionally conveyed to a parallel fermenter(s) running with complementary cycles in such a way that said fermenter is in the feed-elutriate step when the other fermenter(s) is in the fermenting, settling, sludge removal steps. The simplest arrangement is with two fermenters in parallel.

FIG. 5E illustrates the complementary cycles of the two fermenters in parallel, labeled Fermenter A and Fermenter B. The arrow illustrates the time duration of the cycle steps. In this case, with two fermenters in parallel the feeding-elutriating step has the same duration as the other three cycle steps, namely, fermenting (this step can include micro-aeration or fractional aeration), settling and removal of sludge (symbolized by R in FIG. 5E). This sludge removal can occur using an air lift mechanism if desired. Similar complementary cycles can be arranged to run two or more fermenter units in parallel to redirect the flow to one or more of the units when one or more are not receiving wastewater. FIGS. 5A, 5B, 5C, 5D and 5E in combination describes one approach (as a sequenced cycle) to a alternating activated adsorption settler that is used in a primary tank or in place of a primary tank.

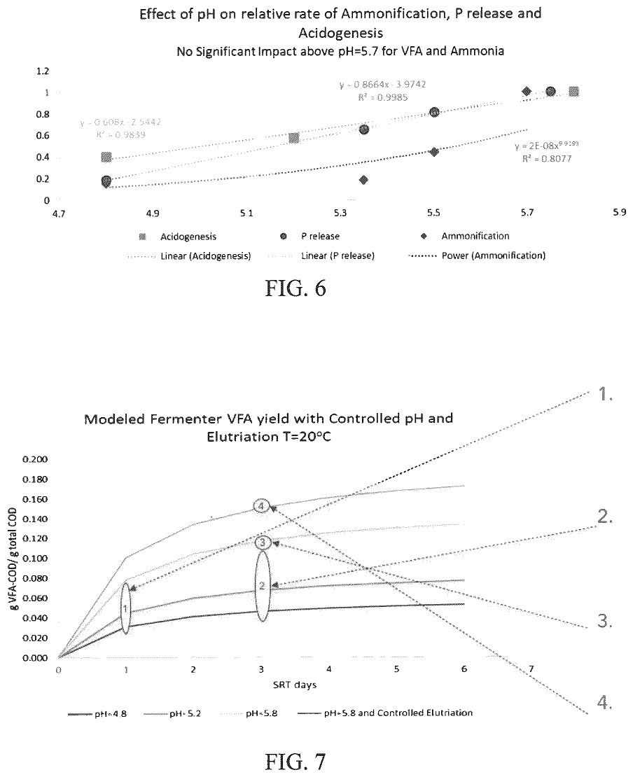

FIG. 6 depicts quantification of pH effects on relative rates of ammonification, P release, and acidogenesis in a series of tests conducted fermenting CEPT primary sludge from in conventional fermenters without elutriation at Blue Plains. All fermentation related rates, acidogenesis, ammonification and phosphorous release reduce with a reduction on pH below 5.9. It can be seen that ammonification and P release are more impacted than acidogenesis. Ammonification appears to be strongly impacted at a pH of 5.7. Impact of pH greater than 5.7 of P release is not quantified or reported in literature. The reduction in fermentation rates, in particular acidogenesis, limits the yields that can be obtained with traditional fermenter technology. Introduction of elutriation during fermentation and other improvements presented in the present invention will enhance rates and improve yields.

FIG. 7 depicts expected VFA yield for a Blue Plains CEPT sludge fermenter with controlled pH and elutriation. Area 1 shows current thickener operations drop pH and inhibits acidogenesis, while pH level depends on changes in alkalinity and iron dosage. Area 2 shows fermenter operation without pH control. Variable VFA gains depend on pH. Area 3 shows pH control at 3 days of SRT provides significant VFA yield gains. Area 4 shows elutriation and pH control further enhance yields. These results illustrate the benefits of the present invention in improving the fermentation process, enabling improved yields, reducing dependence on external carbon sources, and contributing to decarbonization of wastewater treatment operations.

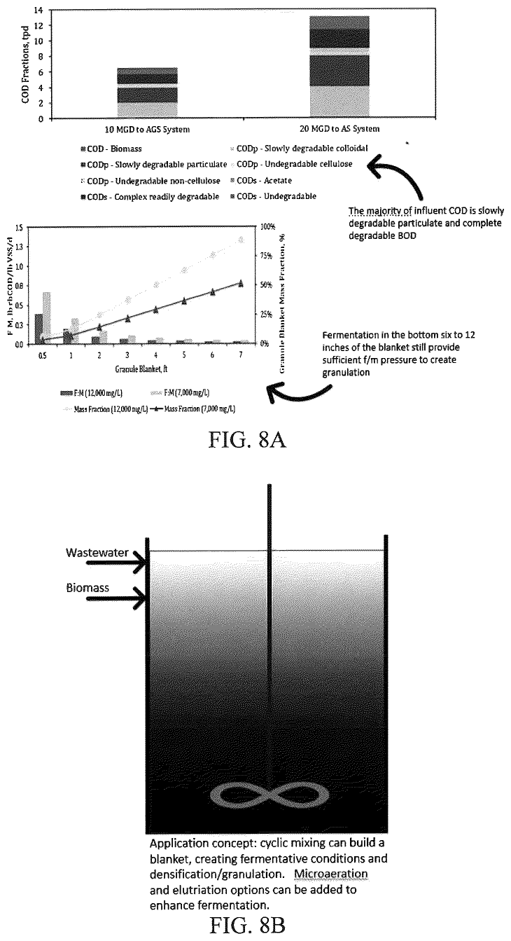

FIG. 8A depicts the impact of VFA on the food to microorganism ratio when wastewater is fed to the bottom of a sludge blanket. An f/m value of 0.25 to 0.5 lbrbCOD/lbVSS-d is required for granule formation. While influent VFA provides a portion of the rbCOD to achieve this f/m, the majority of the rbCOD is generated from influent particulate COD and biomass. The influent particulate COD and biomass are fermented within this sludge blanket, and the fermentation process within the blanket are critical aspects to control and produce granulation in a continuous flow system. The main type of rbCOD required for granulation is VFA, and therefore producing a system that can control the fermentation of particulate into VFA to preferential feed granules would result in control granule formation in a continuous flow system. Our invention describes how control of stratification of solids through cyclic mixer operation, as shown in FIG. 8B, is critical for both fermentation to produce the VFA required for granulation, but also to produce preferential feeding of the more dense granules in an activated sludge system.

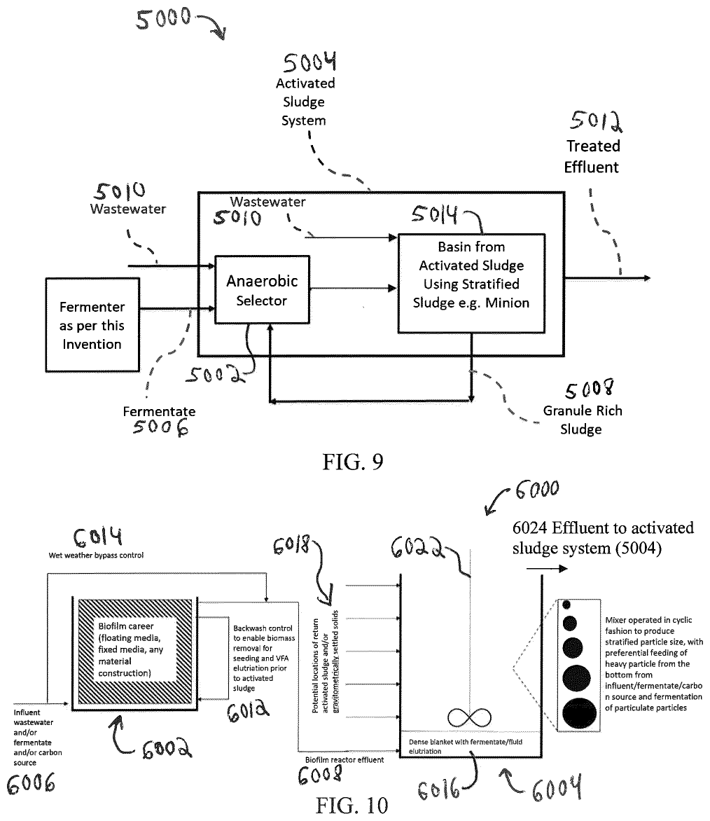

FIG. 9 depicts a system 5000 constructed in accordance with another embodiment of the invention in which fermentate 5006 is preferentially directed from a fermenting system such as fermenting system 1000, 2000, 3000, or 4000 described above to an anerobic selector 5002 and may be contacted by a granule rich sludge/densified solids 5008 from a downstream activated sludge system 5004. In some cases, the anaerobic selector 5002 might also receive wastewater 5010. A contact time of the granule rich sludge/densified solids 5008 in the anaerobic selector 5002 may be 5 minutes, 10 minutes, 15 minutes, 30 minutes, or up to 180 minutes. A shorter contact time may support an aerobic or anoxic selector and a longer contact time will support an anaerobic selector. Effluent 5012 from the anaerobic selector 5002 may be collected and directed to the activated sludge system 5004. The activated sludge system 5004 may include one or a number of basins 5014 equipped with means for stratifying the sludge 5008 within the basin 5014 based on settling velocity of the different sludge components. Stratification may be achieved by controlling the turbulence and mixing intensity of the basin 5014 such that an outlet from the basin at a selected location within the basin selectively withdraws granule rich sludge/densified solids 5008. Stratification can occur along any vector including a vertical or inclined profile in a sequenced or a continuously operated selector. The granule rich sludge/densified solids can also be withdrawn in the effluent 5012, from the selector, based on a mixer that is turned ‘On’ to help transport the mixed content to the downstream activated sludge system, 5004. The granules (or dense particles from a gravimetric selector) are then preferentially directed to the anaerobic selector 5002. In other embodiments, a creation of zones within the basin 5014 with reduced turbulence to achieve stratification is obtained by installing baffles or a combination of baffles and controlled mixing. Mixers could in one embodiment be mechanical mixers such as typically used to mix tanks. The mixer is controlled such that there is always sufficient stratification maintained (such as a min, 10 min, 15 min, 20 min up to 4 hour mixer ‘Off’ cycle). The mixer ‘On’ cycle could vary from seconds to hours depending on the relative need to send flocs or granules (or dense particles) to the downstream zone.

In an embodiment, the return sludge inlet for granule rich sludge/densified solids is preferably introduced in the top 50% of a tank/cell/zone height and the wastewater solids or fermented liquor is added in the bottom 50% of the tank/cell/zone height. A granule rich sludge is herein defined as a sludge containing between 10% to 40% granules or dense solids, and is alternatively called densified solids (solids that partly contain dense solids or granules). The overall process of accumulating densified solids which includes approaches to grow such solids as well as to classify such solids (such as gravimetrically) is called densification.

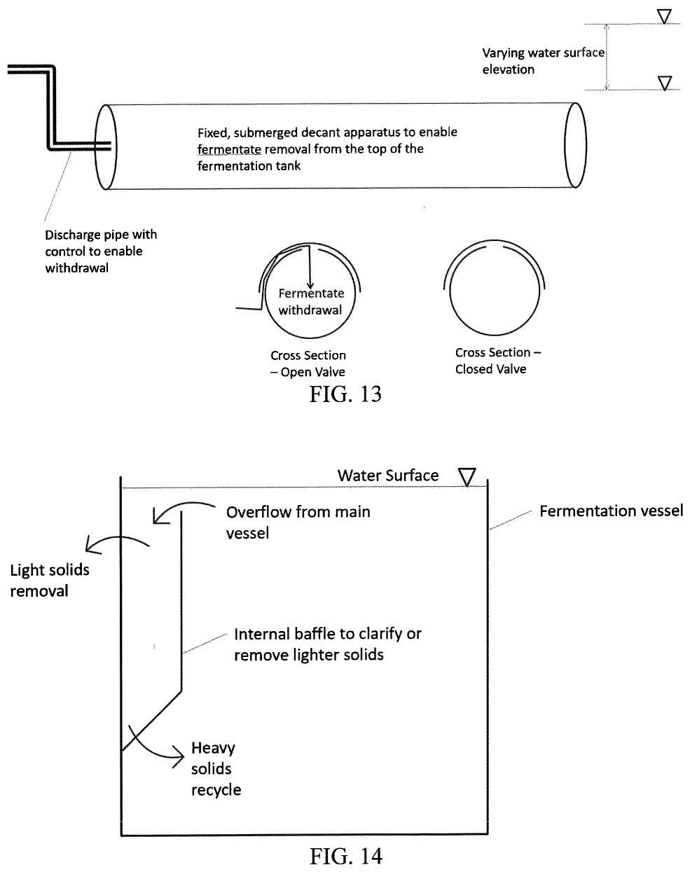

FIG. 10 depicts a system 6000 (an activated sludge system) comprising a pre-conditioning stage 6002, herein a biofilm reactor 6002 (in this case a biological preconditioning stage/step) and an anaerobic/anoxic/aerobic selector 6004 such as represented as 5002 in FIG. 9. The entire system 6000 is not shown but is represented as 5004 in FIG. 9. Fermentation of influent wastewater 6006 (and/or wastewater solids and/or fermentate and/or a carbon source both solid, semi solid or liquid) is achieved in the biofilm/pre-conditioning reactor 6002 prior to its effluent 6008 being fed to an anaerobic zone in the selector 6004. 6008 or bypass 6014 can be fed to 6004, continuously, intermittently or sequentially, depending on the staging that is set-up. While, in this embodiment 6002, is a biological biofilm reactor (any biofilm approach including and not limited to fixed, rotating and moving), this stage can also have a physical or chemical pre-conditioning approach or a combination of pre-conditioning approaches as previously described. This 6002 stage can be both an ‘option’ or a ‘requirement’ depending on the amount of rbCOD (labile COD) needed for generation (typically between 10% to 30% of total COD) and the selector hydraulics. The optional aspect of pre-conditioning can be both in design (i.e. implementation where 6014 becomes the source of wastewater solids or fermentate) or operation (i,e, such as a seasonal requirement or using a bypass 6014 instead of 6008). For example, in warmer climates, this preconditioning stage for particle destruction and rbCOD generation already occurs in sewers and is not needed (can be eliminated). However, the pre-conditioning may be introduced where fermentation is needed and if sufficient hydraulic retention time were not available for particle destruction/fermentation/hydrolysis. Air can be introduced in the preconditioning stage if desired. Enzymes/co-factors/catalysts can be introduced as desired. Sloughing may be needed to control the biofilm formed. Gas or mechanical (including mechanical, hydraulic, acoustic or vibratory) mixing may be introduced to manage mass transfer (both liquid-liquid and liquid-solid). The biofilm reactor 6002 may utilize floating media, fixed media, or any material construction. Backwash control 6012 may be utilized to enable biomass removal for seeding and VFA elutriation prior to activated sludge. Mixing or mass-transfer devices can be introduced and deliberate sloughing of biofilm can be achieved as needed. The biofilm can be removed continuously or periodically, and either sent to the downstream selector, 6004 or to a sludge management process. Seasonal or wet weather bypass control 6014 may be utilized to bypass the biofilm reactor 6002. An optional dense blanket 6016 with fermentate formation/fluid elutriation may be present at the bottom of the selector 6004 with its own mixing device (such as a draft tube or a scouring device). This embodiment may provide several potential locations 6018 of return activated sludge and/or gravimetrically settled solids entering the selector 6004 as shown (preferably introduced in the top 50% of reactor height). A mixer 6022 in the selector 6004 may be operated in cyclic fashion to produce stratified particle sizes, with preferential feeding of heavy particles from the bottom of the selector 6004 of influent/fermentate/carbon source 6008 and fermentation of particles. Stratification can occur along any vector including a vertical or inclined profile in a sequenced or a continuously operated selector. The granule/carrier rich sludge can also be withdrawn with the effluent from the reactor (6024) and conveyed to an activated sludge system (5004) from the selector, based on a mixer that is turned ‘On’ to help transport the mixed content to the downstream activated sludge system, 5004 (as described in 5009) and sent to the remainder tanks/zones in 6000. The effluent may be withdrawn hydraulically, such as through or over a baffle wall, or using devices such as shown in FIGS. 13 and 14 (described below). If the feed to the selector is intermittent or sequenced, the air-lock decanter in FIG. 13 can be activated during the feed 6008 or 6014, mixer 6022 ‘Off’ mode, discharge 6024. Alternatively, the feed could be continuous (with a small change in volume of selector liquid level) and the stratified discharge could be set up as intermittent when the mixer 6022 is ‘Off’. This volume increase occurs because the decanter is locked during bursts of mixing. For a continuous discharge, a baffle wall such as in FIG. 14 may be preferred, where the wall assists with the stratification. As differentiated particles are ‘groomed’ in the selector, the stratification becomes simpler to achieve. The selector 6002 may also consist of migrating carriers, such as sourced from plant-based material to help with grooming the stratification and selection of dense material. The entire approach for such selection and grooming of particles using substrate gradients with the right quantity and quality of substrates produces during pre-conditioning and fermentation promotes the concept of densification as complementary to gravimetric selection.

Mixers such as mixer 6022 could in one embodiment be mechanical mixers such as typically used to mix tanks. The mixer is controlled such that there is always sufficient stratification maintained (such as a 5 min, 10 min, 15 min, 20 min up to 4 hour mixer ‘Off’ cycle). Turning the mixer ‘Off’ helps establish stratification along a vertical or incline depending on the trajectory of flow. The mixer ‘On’ cycle could vary from seconds to hours depending on the relative need to send flocs or granules to the downstream zone or the relative size of granule being sculpted by the selector. Granule sculpting is a unique inventive step where the size fractions of granules are established by the mixing and the substrate gradient fed from the fermenter. Thus, the fermenter COD concentration and the stratification developed from a mixer cycle can help establish the preferred size of particles in the range of 100 microns to 500 microns. The stratification also supports migrating carriers such as those developed using plant-based material or other natural or synthetic materials. Here the stratification associated with migrating carriers brings them to the bottom for luxury uptake of the COD from the fermentate for storage or to drive the gradient associated with diffusion.

In an embodiment, the return sludge inlet for granule rich sludge, 6018 is preferably introduced in the top 50% of a tank/cell/zone height and the wastewater solids or fermented liquor, 6008 is added in the bottom 50% of the tank/cell/zone height or preferably using a feed manifold at the bottom of the selector. The densified solids formed and supported by the configuration in FIG. 10 helps reduce nitrous oxide formation by supporting a more diverse physiology and morphology of particles with multiple affinities for ammonia, oxygen and inorganic carbon. Some or the moderate to heavier solids or carriers, reside in the system for a longer solids residence time, and hence can support slower growing organisms, such as for example, comammox. This diversity of organisms (including slow growers) and affinities (half saturations used for modeling of Monod equations) allow for more complete nitrification and avoidance of N2O formation, especially under low dissolved oxygen conditions. The use of large granules are avoided but the development of niche morphologies for managing nitrification is a key feature of this invention. Another inventive feature is the storage rbCOD as biopolymers including internal (e.g., glycogen and polyhydroxyalkanoate) or external products. This carbon can be used in the anoxic step for denitrification including for N2O mitigation and for process such as partial denitrification and anammox. In one embodiment, a sensor, including and not limited to soft sensors, COD, pH or ORP is used to monitor the hydrolysis, fermentation and/or storage reactions.

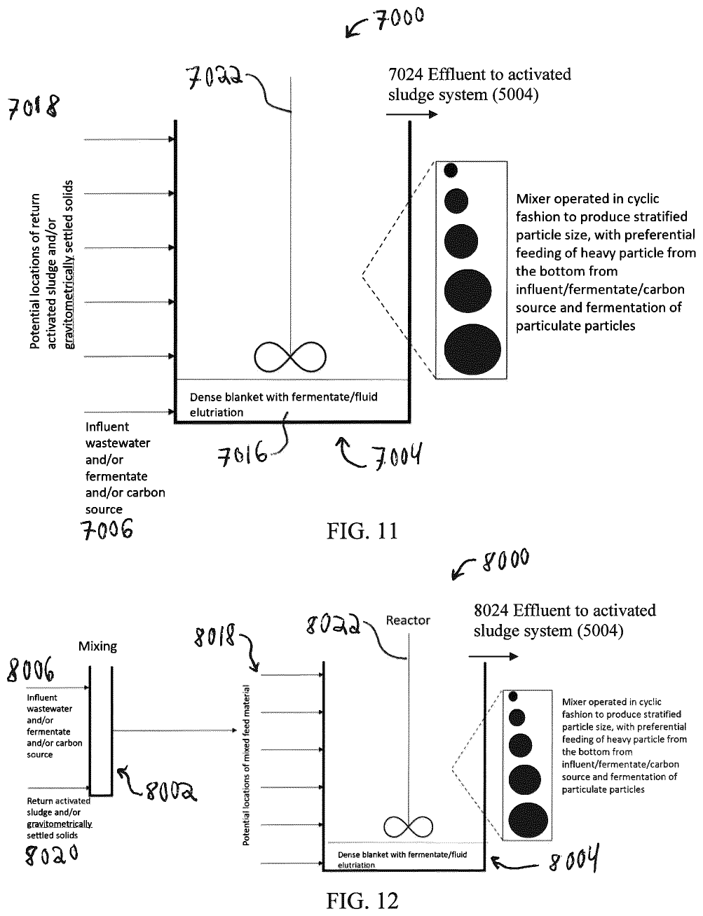

FIG. 11 depicts an activated sludge system 7000 comprising an aerobic, anoxic or anaerobic selector 7004. Fermentation of influent wastewater 7006 (and/or fermentate produced from another reactor or process, and/or a carbon source) is fed to the selector 7004 preferrably at the bottom or in the bottom 50% of the selector. An optional dense blanket 7016 with fermentate/fluid elutriation may be present at the bottom of the selector 7004 especially if fermentate is not already present in the influent wastewater 7006 stream. This embodiment may provide several potential locations 7018 of return activated sludge and/or gravimetrically settled solids (preferably in the upper 50% of a reactor at one or more locations) entering the selector 7004 as shown. A mixer 7022 in the selector 7004 may be operated in cyclic fashion to produce stratified particle sizes, with preferential feeding of heavy particles from the bottom of the selector 7004 of influent/fermentate/carbon source and fermentation of wastewater solids. Importantly, in this embodiment, return activated sludge 7020 and influent wastewater 7006 (and/or fermentate and/or carbon) are fed separately to the selector 7004 such as represented as 5002 in FIG. 9. The entire system 7000 is not shown but is represented as 5004 in FIG. 9. Fermentation of influent wastewater 7006 (and/or wastewater solids and/or fermentate and/or a carbon source both solid, semi solid or liquid) is achieved preferably prior to is being fed to the selector 7004 continuously, intermittently or sequentially, depending on the staging that is set-up. Stratification can occur along any vector including a vertical or inclined profile in a sequenced or a continuously operated selector. The granule rich sludge (or carrier contained or densified solids) can also be withdrawn with the effluent from the reactor (7024) and conveyed to an activated sludge system (5004) from the selector, based on a mixer that is turned ‘On’ to help transport the mixed content to the downstream activated sludge system, 5004 (as described in 5009) and sent to the remainder tanks/zones in 7000. The effluent may be withdrawn hydraulically, such as through or over a baffle wall, or using devices such as shown in FIGS. 13 and 14. If the feed to the selector is intermittent or sequenced, the air-lock decanter in FIG. 13 can be activated during the feed 7006, mixer 7022 ‘Off’ mode, discharge 7024. Alternatively, the feed could be continuous (with a small change in volume of selector liquid level) and the stratified discharge could be set up as intermittent when the mixer 7022 is ‘Off’. This volume increase occurs because the decanter is locked during bursts of mixing. For a continuous discharge, a baffle wall such as in FIG. 14 may be preferred, where the wall assists with the stratification. As differentiated particles are ‘groomed’ in the selector, the stratification becomes simpler to achieve. The selector 7002 may also consist of migrating carriers, such as sourced from plant-based material to help with grooming the stratification and selection of dense material. The entire approach for such selection and grooming of particles using substrate gradients with the right quantity and quality of substrates produces during pre-conditioning and fermentation promotes the concept of densification as complementary to gravimetric selection.

Mixers such as mixer 7022 could in one embodiment be mechanical mixers such as typically used to mix tanks. The mixer is controlled such that there is always sufficient stratification maintained (such as a 5 min, 10 min, 15 min, 20 min up to 4 hour mixer ‘Off’ cycle). Turning the mixer ‘Off’ helps establish stratification along a vertical or incline depending on the trajectory of flow. The mixer ‘On’ cycle could vary from seconds to hours depending on the relative need to send flocs or granules to the downstream zone or the relative size of granule being sculpted by the selector. Granule sculpting is a unique inventive step where the size fractions of granules are established by the mixing and the substrate gradient fed from the fermenter. Thus, the fermenter COD concentration and the stratification developed from a mixer cycle can help establish the preferred size of particles in the range of 100 microns to 500 microns. The stratification also supports migrating carriers such as those developed using plant-based material or other natural or synthetic materials. Here the stratification associated with migrating carriers brings them to the bottom for luxury uptake of the COD from the fermentate for storage or to drive the gradient associated with diffusion.

In an embodiment, the return sludge inlet for granule rich sludge (or densified solids), 7018 is preferably introduced in the top 50% of a tank/cell/zone height and the wastewater solids or fermented liquor, 6008 is added in the bottom 50% of the tank/cell/zone height or preferably using a feed manifold at the bottom of the selector. The densified solids formed and supported by the configuration in FIG. 10 helps reduce nitrous oxide formation by supporting a more diverse physiology and morphology of particles with multiple affinities for ammonia, oxygen and inorganic carbon. Some or the moderate to heavier solids or carriers, reside in the system for a longer solids residence time, and hence can support slower growing organisms, such as for example, comammox. This diversity of organisms (including slow growers) and affinities (half saturations used for modeling of Monod equations) allow for more complete nitrification and avoidance of N2O formation, especially under low dissolved oxygen conditions. The use of large granules are avoided but the development of niche morphologies for managing nitrification is a key feature of this invention. Another inventive feature is the storage rbCOD as biopolymers including internal (e.g., glycogen and polyhydroxyalkanoate) or external products. This carbon can be used in the anoxic step for denitrification including for N2O mitigation and for process such as partial denitrification and anammox. In one embodiment, a sensor, including and not limited to soft sensors, COD, pH or ORP is used to monitor the hydrolysis, fermentation and/or storage reactions.

FIG. 12 depicts an activated sludge system 8000 comprising a pre-mixer 8002 and a selector 8004. Influent wastewater 8006 (and/or fermentate and/or a carbon source) and return activated sludge 8020 are mixed in the pre-mixer 8002 to form a mixed feed material. This embodiment may provide several potential locations 8018 of the mixed feed material entering the selector 8004 as shown. A mixer 8022 in the selector 8004 may be operated in cyclic fashion to produce stratified particle sizes, with preferential feeding of heavy particles from the bottom of the selector 8004 of the mixed feed material and fermentation of particles. Importantly, in this embodiment, the influent wastewater 8006 (and/or fermentate and/or carbon source) and return activated sludge 8020 are mixed prior to feeding to the selector 8004. Effluent from the reactor (8024) is conveyed to an activated sludge system (5004). All else may be similar for this system as seen in FIG. 11.

FIG. 13 shows an air-lock decanter assembly that allows for a sequenced approach (in a primary, anaerobic zone of a secondary, a gravity thickener, or an acid digester to be alternately aerated/mixed and decanted. The decanter is fixed at a location, thus maintaining a hydraulic profile and may replace an existing weir at the same or different location or height from the existing weir. The decanter placed in a tank to maximize the depth of elutriation available in the tank. The decanter is locked (using an air lock) such that the decanter can be immersed in the mix, aerate or stabilizer mode to maximize tank volume for hydrolysis or fermentation and the same decanter is used for elutriation and discharge and can behave similar to a weir when the air lock is released. The use of this decanter for discharge of elutriate is an inventive embodiment. This decanter can also be used in a sequenced anaerobic selector to provide a maximum depth for vertical contact of a fermented liquor across a vertical or inclined vector of a reactor while also allowing for the production of a fermentate in a mix cycle.

A key feature of the use of this decanter or otherwise prepared elutriate for/from primary treatment is this highly degradable fermentate is suitable for downstream (biological secondary reactor/process) granule (dense solids) formation/selection in an anaerobic or anoxic or aerobic selector, or for controlling the production of nitrous oxide (N2O) within anoxic zones of a secondary reactor/process producing (such as using a membrane aerated biofilm reactor) or being fed nitrate directly or in recycles. This granule selection can occur using stratification inspired by intermittent mixing within the selector especially when the elutriate is fed and/or distributed continuously or intermittently from the bottom with return activated sludge being added in a mid-section.

The decanter can alternatively be used in a selector zone 6004 or at the end of an activated sludge system 6000 in FIG. 10 to provide gravimetric classification.

FIG. 14 shows an internal baffle wall that can be used to clarify or remove lighter fraction of stratified solids for removal. The baffle wall as an inclusive and not limited to embodiment, is typically made from stainless steel, fiberglass or a polymer (such as polyproplyne) or can be pre-cast in concrete, and can be easily installed to promote stratification and to maximize the classification of lighter material being sent downstream while exposing the heavier fraction (such as densified sludge or granules) to a prepared elutriate or wastewater solids. The baffle wall allows for the conversion of any tank into a classifier and is beneficial especially in the front end of a reactor consisting of tanks or zones such as an anaerobic or anoxic selector tank/zone or in the back end of a reactor tank/zone before discharging into a clarifier. This classification baffle provides conditions for sufficient selection of lighter fraction to a downstream process and retention of a heavier fraction for recycling. The classification can be further inspired by adjusting mixing or aeration. A key feature of the use of this baffle wall or otherwise prepared elutriate for/from primary treatment is this highly degradable fermentate is suitable for downstream (biological secondary reactor/process) granule (dense solids) formation/selection in an anaerobic or anoxic or aerobic selector, or for controlling the production of nitrous oxide (N2O) within anoxic zones of a secondary reactor/process producing (such as using a membrane aerated biofilm reactor) or being fed nitrate directly or in recycles. This granule/dense solids selection can occur using stratification inspired by mixing within the selector especially when the elutriate is fed and/or distributed continuously or intermittently from the bottom with return activated sludge being added in a mid-section. The feed and return sludge can also be comingled as shown in FIG. 5. The baffle wall can alternatively be used in a selector zone 6004 or at the end of an activated sludge system 6000 in FIG. 10 to provide gravimetric classification. The baffle wall in one preferred embodiment is slotted to assist in hydrodynamics of solids/flow.

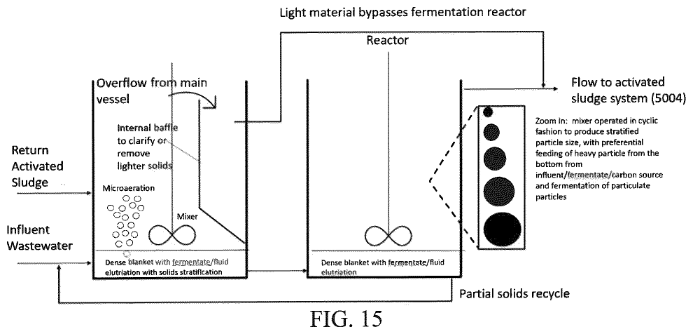

FIG. 15 shows a pre-contact zone providing contact of wastewater with return activated sludge solids in an initial reactor vessel. Stratification of solids is enabled via controlled mixing. An internal baffle directs light solids to a downstream reactor vessel. Heavier solids are directed to a fermentation reactor vessel (see FIGS. 11 and 12). The fermented solids are combined with the lighter solids fraction in the downstream reactors. FIG. 15. represents two tanks (such as primary tanks) or zones (such as anaerobic zones) or thickeners or digesters in series. The reactor is operated in a contact stabilization mode, either with an optional internal or external clarifier (such as an internal or external lamella or an internal baffle wall as shown in FIG. 14) or a conventional clarifier. The feed is added to the contact zone and the baffle clarifies/elutriates the effluent. The solids are recycled to an upstream stabilization zone for fermentation, where micro-aeration or fractional aeration is applied to suitably activate and convert the particulates to fermentate. The addition of micro-aeration provide some lift that in some cases provides sufficient lift to allow for flow of liquor from the stabilization tank to a contact tank. The sludge recycle from the bottom of the settle zone occurs using a pump or an air-lift approach from the contact tank to the stabilization tank. Alkalinity can be added to manage pH, as needed, to provide inorganic carbon for downstream processes as well as to mitigate against product inhibition from unionized volatile fatty acid constituents. In one embodiment, elutriate can be admitted to either of the contact or stabilization zone as needed to manage product inhibition. A sensor (including and not limited to soft sensors) can be used to manage, pH, ORP or to monitor for COD formation. The sensor can also be used to mitigate methane formation.

The shape and dimensions of the reactor, tanks, stages or zones are a representation only. Any dimension and shape are possible as long as the physical, chemical and biological processes and reactions envisioned in embodiments are undertaken in those dimensions and shapes.

The feed, recycle and discharge locations are preferred embodiments and other such approaches for feed, recycle and discharge are possible.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth in any subsequent regular utility patent application. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims included in any subsequent regular utility patent application a non are not intended to be construed under 35 U.S.C. § 112 (f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

What is claimed is:

1. An intensified fermentation reactor system comprising:
a pre-conditioning stage configured to one or more of physically, chemically, or biologically precondition wastewater solids comprising a particulate COD stream;
a micro-aeration or fractional aeration stage configured to activate fermentation;
an elutriation stage configured to elutriate fermentation; and
an instrumentation and control system configured to effect feedback control of elutriation thereby optimizing diversion of COD for energy production while maintaining an effluent limit.

2. The intensified fermentation reactor system of claim 1, wherein the intensified fermentation reactor system is configured to process at least one of a primary sludge and return activated sludge, source-separated organics (SSOs) and food waste.

3. The intensified fermentation reactor system of claim 1, wherein the intensified fermentation reactor system at least one of reduces volume requirements, reduces chemical including alkalinity addition, reduces external carbon addition, reduces N₂O emissions associated with biological nutrient removal in a downstream biological treatment, promotes densification, or increases gas production in anaerobic digestion.

4. A fermenting system comprising:
a wastewater solids source;
an elutriant source;
a fermenter vessel configured to receive wastewater solids from the wastewater solids source, receive elutriant from the elutriant source, ferment sludge, and remove an elutriated product from the fermenter vessel.

5. The fermenting system of claim 4, further comprising at least one of means for adding one or more chemicals, a pH control subsystem, and ORP control subsystem.

6. The fermenting system of claim 4, the fermenter vessel further comprising an internal clarifier/settler/decanter configured to form a quiescent zone, means for receiving fermenting mixed liquor in a fermenter mixing zone, means for clarifying the fermenting mixed liquor thereby forming a clarified liquid and a settled sludge, and means for collecting the clarified liquid and means for returning the settled sludge to the fermenter mixing zone.

7. The fermenting system of claim 4, wherein the fermenting system is configured to mix the sludge and withdraw the sludge via compressed air.

8. The fermenting system of claim 4, wherein the fermenting system is configured to withdraw the elutriated product by allowing a surface water level in the fermenter vessel to drop.

9. The fermenting system of claim 4, wherein the fermenting system is configured to introduce elutriant via distributing flow across a plurality of depths below a surface water level of the fermenting vessel and collect the elutriated product at a fixed surface water level.

10. The fermenting system of claim 4, wherein the elutriant is pretreated wastewater containing wastewater solids and the elutriated product is transported to a biological nutrient removal (BNR) system.

11. The fermenting system of claim 4, wherein the fermenter vessel is operated in parallel with an additional fermenter vessel and cycled so that at least one of the fermenter vessels receives wastewater at any given time.

12. A fermentation apparatus for treatment in: a selector zone or zones of a biological reactor or reactors for primary treatment of screened or degritted wastewater, a fermenter for primary sludge, or an acid sludge digester of primary sludge, waste activated sludge, food waste or any combination of sludges or waste, the fermentation apparatus comprising:
a micro-aeration or fractional aeration tank, stage, cycle or zone configured to activate fermentation;
a settle tank, stage, cycle or zone;
an optional sludge withdrawal using a pump or an air lift mechanism wherein the sludge withdrawal is sent to an optional thickening tank, stage, cycle or zone,
an elutriation tank, stage, cycle or zone configured to elutriate fermentate using a liquid elutriate includes one or more of wastewater solids, primary influent, primary effluent, secondary influent or other water sources in a treatment plant; and
a discharge of fermented elutriate though a baffle, decanter or weir,
wherein at least two tanks, stages, cycle or zones are configured in a timed sequence in parallel or a flow-through approach in series, and
wherein, either the micro-aeration is operated at a low dissolved oxygen concentration or an ORP of +20 mv to −400 mV, or fractional aeration comprises 5% to 20% of the retention time in a tank, stage, overall cycle or zone, and
wherein the readily biodegradable COD in the effluent tank, stage, overall cycle or zone comprises at least 20% of the influent COD.

13. The apparatus of claim 12, wherein clarified liquid is withdrawn at a plurality of water levels in the fermentation apparatus.

14. The apparatus of claim 12, wherein the fermentation apparatus includes an internal dedicated quiescent zone for settlement of sludge, return of settled sludge, and collection of clarified liquid.

15. An activated sludge system comprising:
a pre-conditioning stage configured to one or more of physically, chemically, or biologically precondition wastewater solids and an effluent;
an aerobic, anoxic or anaerobic selector stage for feeding, fermentation and stratification of preconditioned effluent or a wastewater influent, the selector receiving a densified solids flow from one or more of a return activated sludge, a recycle, gravimetrically selected solids or migrating carriers,
an optional elutriation configured to elutriate fermentation of a blanket;
the selector is configured for continuous, intermittent or sequence mixing of influent and densified solids or migrating carriers;
wherein the fermentation system supports densification, uncoupling solids residence time of different solids or carrier fractions, or nitrous oxide reduction in either the denitrification or nitrification pathways.

16. The system of claim 15, wherein the elutriated product is directed to an anaerobic selector and mixed at least with a granule rich stream from an activated sludge basin operated to have a stratified sludge.

17. The system of claim 15, where the fermenter vessel incorporates a biofilm carrier media with means for controlling the biofilm depth, and the elutriated product including wastewater solids is directed to the bottom of a mixed vessel operated with intermittent mixing generating a stratified particle size with heavier particles in the bottom.

18. The system of claim 15, where the elutriated product including wastewater solids is directed to the bottom of a mixed vessel operated with intermittent mixing generating a stratified particle size with heavier particles in the bottom.
